(19) United States
(12) Patent Application Publication
(10) Pub. No.: US 2025/0243055 A1
(43) Pub. Date: Jul. 31, 2025

(54) METHOD FOR MAKING LOW CARBON INTENSITY HYDROGEN

(71) Applicant: Iogen Corporation, Ottawa (CA)

(72) Inventor: Brian Foody, Ottawa (CA)

(21) Appl. No.: 18/853,698

(22) PCT Filed: Apr. 7, 2023
(86) PCT No.: PCT/CA2023/050486

§ 371 Date: Oct. 2, 2024

Related U.S. Application Data
(63) Continuation-in-part of application No. 18/162,950, filed on Feb. 1, 2023, now Pat. No. 11,807,530.
(60) Provisional application No. 63/379,951, filed on Oct. 18, 2022.
(60) Provisional application No. 63/362,788, filed on Apr. 11, 2022.
(60) Provisional application No. 63/362,788, filed on Apr. 11, 2022.

(51) Int. Cl. C01B 3/38; C01B 3/56; C01C 1/04

(52) U.S. Cl. CPC C01B 3/38; C01B 3/56; C01C 1/04; C01B 2203/0233; C01B 2203/042; C01B 2203/1241; C01B 2203/86

(57) ABSTRACT

The present disclosure provides a method for reducing the carbon intensity of hydrogen by replacing, at a hydrogen production facility, a fraction of a non-renewable gaseous feedstock with a biomethane feedstock, wherein the non-renewable gaseous feedstock replaced is (a) a feedstock fed to methane reforming and/or (b) a feedstock used to generate heat for the reforming in the hydrogen production. The fraction of non-renewable gaseous feedstock replaced by the biomethane feedstock is less than 50%, yet the hydrogen produced has a carbon intensity that is 10 gCO_{2eq}/MJ H₂ (LHV) or lower. The biomethane feedstock in some examples has a carbon intensity (CI) value within a range that is between 15 gCO_{2eq}/MJ and −500 gCO_{2eq}/MJ.

### TECHNICAL FIELD

The disclosure relates to a process for producing hydrogen having a carbon intensity equal to or lower than a target carbon intensity.

### BACKGROUND

Hydrogen is a ubiquitous fuel used in a wide range of industries. Its most common and established use is in hydroprocessing units of oil refineries where it is used to upgrade crude oil derived streams to make gasoline and other refinery products. However, hydrogen also finds use in the established Haber-Bosch process to make ammonia. More recently, there has been interest in its direct use as a fuel for automobiles and in fuel cells.

A common method to make hydrogen is by a process referred to as reforming. Reforming involves reacting methane in the presence of a catalyst typically to make syngas, which comprises hydrogen and carbon monoxide, among other components, with an optional step of a water-gas shift to produce more hydrogen.

A conventional reforming process uses natural gas as a feedstock. While natural gas is abundant and readily available, it is fossil-derived and is associated with high carbon intensity. More environmentally-friendly processes to make hydrogen, such as by electrolysis, using solar energy and biological processes, are potential alternatives, but are still in various phases of research and development. In addition, these green alternatives are capital intensive and therefore challenging to implement on a commercial scale.

While the continued use of reforming to make hydrogen from natural gas avoids the high cost of replacing or modifying the existing process with the greener alternatives, there still remains a high demand for clean hydrogen (low or negative carbon intensity (CI) or hydrogen produced through processes that have lower lifecycle greenhouse gas emissions). Indeed, policy-makers around the world are pushing for ever-lower carbon content in fuels and industrial products, and many countries have either legislated or are in the process of implementing legislation setting out clean hydrogen targets. This includes, for example, the potential Build Back Better Bill in the United States. However, in order for hydrogen producers to benefit the most from such legislation, a reduction in carbon intensity relative to conventional fossil-based hydrogen production typically is needed. In some instances, the target set by regulations may be as much as a 95% or more reduction in lifecycle greenhouse gas (GHG) emissions (relative to a predetermined baseline) to achieve maximum benefits (e.g., in the form of fuel credits or other credits), but this is challenging to achieve without incurring significant capital cost.

There is a need for hydrogen production facilities, including but not limited to those that have already implemented GHG emissions reductions, to satisfy ever-increasing clean hydrogen standards. The disclosure addresses this need and/or provides useful alternatives to known processes so as to produce hydrogen that meets a target carbon intensity.

### SUMMARY

The present disclosure addresses one or more of the foregoing needs and/or problems in the art.

In particular, the present disclosure provides a process that enables hydrogen produced in a hydrogen production facility to meet a target CI (i.e., have a CI equal to or lower than the target CI), where the hydrogen is produced using feedstock that includes both non-renewable gaseous feedstock (e.g., fossil-based natural gas) and biomethane feedstock, and where the process includes carbon capture and sequestration (CCS). In certain embodiments, the CCS includes capturing carbon dioxide from one or more points in the process having a relatively high carbon dioxide content and/or pressure (i.e., relative to flue gas). Advantageously, this may increase the amount of carbon stored, and thus the potential GHG emission reductions, for a given cost of capturing and sequestering the carbon. Alternatively, or additionally, it may increase the amount of carbon stored, for a given amount of biomethane feedstock (e.g., required to meet the target CI). In some embodiments, the method achieves 80% or more reductions in GHG emissions (relative to a predetermined baseline) associated with hydrogen production. Advantageously, this enables maximum benefits in the form of government incentives, such as fuel credits or other credits, to incentivize clean hydrogen production. At the same time, some of the processes disclosed herein advantageously avoid or reduce any additional capital cost that may otherwise be needed to meet such high GHG emissions target reductions.

In one aspect, the present disclosure provides a method of producing hydrogen that meets a target carbon intensity (CI_{T}) that is 10 gCO₂eq/MJ H₂ (LHV) or lower, the method comprising: (i) operating a hydrogen production facility that produces hydrogen by reforming gaseous feedstock, the gaseous feedstock comprising non-renewable gaseous feedstock, the reforming generating syngas, the syngas subjected to hydrogen purification, the hydrogen production generating carbon dioxide, at least some of the carbon dioxide captured and provided for sequestration; (ii) providing biomethane feedstock produced in a biomethane production process that generates carbon dioxide, at least some of the generated carbon dioxide provided for sequestration; (iii) replacing a fraction of the non-renewable gaseous feedstock used for producing the hydrogen with the biomethane feedstock, thereby producing hydrogen having a carbon intensity reduced relative to hydrogen produced without the replacing, wherein the non-renewable gaseous feedstock replaced is (a) feedstock fed to methane reforming, (b) feedstock used to generate heat for the reforming, or (c) a combination thereof, wherein the fraction of the non-renewable gaseous feedstock replaced is less than 50%, and wherein the fraction is selected to meet the target carbon intensity (CI_{T}); and (iv) obtaining the hydrogen having the reduced carbon intensity, the reduced carbon intensity being at least as low as the target carbon intensity (CI_{T}) and being dependent, at least in part, on the carbon intensity of the non-renewable gaseous feedstock and the biomethane feedstock.

In one aspect, the present disclosure provides a method of producing hydrogen that meets a target carbon intensity (CI_{T}) that is 10 gCO₂eq/MJ H₂ (LHV) or lower, the method comprising: (i) providing biomethane feedstock for hydrogen production, the biomethane feedstock produced in a biomethane production process comprising anaerobic digestion, the anaerobic digestion generating biogas and digestate, the biogas comprising carbon dioxide, at least some of the carbon dioxide from the biogas captured and provided for sequestration, at least a portion of the digestate combusted, combustion of the digestate producing a first flue gas comprising carbon dioxide, at least some of the carbon dioxide from the first flue gas captured and provided for sequestration, the hydrogen production including subjecting gaseous feedstock to steam methane reforming, the gaseous feedstock comprising non-renewable gaseous feedstock, the steam methane reforming generating syngas and a second flue gas, the syngas comprising hydrogen and carbon dioxide, the syngas subjected to hydrogen purification, at least some of the carbon dioxide from the syngas captured and provided for sequestration; (ii) replacing a fraction of the non-renewable gaseous feedstock used for producing the hydrogen with the biomethane feedstock, thereby producing hydrogen having a carbon intensity reduced relative to hydrogen produced without the replacing, wherein the non-renewable gaseous feedstock replaced is (a) feedstock fed to methane reforming, (b) feedstock used to generate heat for the reforming, or (c) a combination thereof, wherein the fraction of the non-renewable gaseous feedstock replaced is less than 50%, and wherein the fraction is selected to meet the target carbon intensity (CI_{T}); and (iii) obtaining the hydrogen having the reduced carbon intensity, the carbon intensity being at least as low as the target carbon intensity (CI_{T}) and being dependent, at least in part, on the carbon intensity of the non-renewable gaseous feedstock and the biomethane feedstock.

In one aspect, the present disclosure provides a method of producing hydrogen that meets a target carbon intensity (CI_{T}) that is 10 gCO₂eq/MJ H₂ (LHV) or lower, the method comprising: (i) determining a carbon intensity of hydrogen produced at a hydrogen production facility, the hydrogen production facility configured to produce hydrogen by reforming gaseous feedstock, thereby generating carbon dioxide, and configured to capture at least some of the carbon dioxide, the determined carbon intensity higher than the target carbon intensity (CI_{T}), the determined carbon intensity accounting for the gaseous feedstock comprising non-renewable gaseous feedstock and for the captured carbon dioxide being sequestered; (ii) determining a fraction of the non-renewable gaseous feedstock to be replaced with biomethane feedstock to produce hydrogen that meets the target carbon intensity (CI_{T}), the biomethane feedstock produced in a biomethane production process that generates carbon dioxide, at least a portion of the carbon dioxide generated provided for sequestration, wherein the non-renewable gaseous feedstock replaced is (a) feedstock fed to methane reforming, (b) feedstock used to generate heat for the reforming, or (c) a combination thereof, and wherein the fraction of the non-renewable gaseous feedstock replaced is less than 50%; and (iii) providing the biomethane feedstock for use at the hydrogen production facility, the biomethane feedstock provided used to produce hydrogen in a process comprising: (a′) providing feedstock comprising the non-renewable gaseous feedstock and the biomethane feedstock for the reforming, thereby generating syngas comprising hydrogen, carbon monoxide, and carbon dioxide, an amount of biomethane feedstock in the feedstock determined in dependence upon the fraction determined in (ii); (b′) subjecting the syngas to hydrogen purification; and (c′) capturing at least a portion of the carbon dioxide from the syngas, from off-gas from hydrogen purification, or a combination thereof, and providing the captured carbon dioxide for sequestration, wherein the hydrogen produced has a carbon intensity that meets the target carbon intensity (CI_{T}) and is dependent, at least in part, on the carbon intensity of the non-renewable gaseous feedstock and the biomethane feedstock.

### BRIEF DESCRIPTION OF THE DRAWINGS

FIG. 1A describes an embodiment of a process for producing low carbon intensity (CI) hydrogen comprising replacing a fraction r of natural gas with a biomethane feedstock in steam methane reforming (SMR) in a hydrogen production facility that is part of an oil refinery.

FIG. 1B describes a baseline process for producing hydrogen that is carried out without replacing a fraction r of natural gas with a biomethane feedstock in the SMR of an oil refinery.

FIG. 1C is a graph showing biomethane feedstock CI in gCO2eq/MJ vs a biomethane feedstock share of gas flow in the SMR to achieve a 95% GHG reduction of the hydrogen relative to a baseline.

FIG. 2A shows an embodiment of the process in which carbon dioxide collected from biomethane upgrading is sequestered underground to produce a low CI biomethane feedstock for use in replacing a fraction of natural gas in the SMR.

FIG. 2B shows an embodiment of the process in which a solid residue from anaerobic digestion in the form of a digestate is processed and sequestered underground or optionally used as fertilizer to produce a low CI biomethane feedstock for use in replacing a fraction of natural gas in the SMR.

FIG. 2C shows an embodiment of the process in which a stream of low CI biomethane is used in a step of biomethane production that comprises biomethane upgrading to produce a low CI biomethane feedstock for use in replacing a fraction of natural gas in the SMR.

FIG. 2D shows an embodiment of the process in which a stream of low CI biomethane is used in a step of biomethane production that comprises collecting methane from an animal waste, thereby avoiding methane emissions that would otherwise be released to the atmosphere.

### DETAILED DESCRIPTION

### Producing a Biomethane Feedstock

The process(es) and/or system(s) of the present disclosure use a biomethane feedstock derived in some embodiments from biogas produced from biomass. Biomass refers to organic material originating from plants, animals, or micro-organisms (e.g., including plants, agricultural crops or residues, municipal wastes, animal wastes and algae). Biomass is a renewable resource, which can be naturally replenished on a human timescale, and which can be used to produce bioenergy and/or biofuels (e.g., biogas). Some examples of suitable biomass may include: (i) energy crops (e.g., switchgrass, sorghum, and the like); (ii) residues, byproducts, or waste from the processing of plant material in a facility, or feedstock derived therefrom (e.g., sugarcane bagasse, sugarcane tops/leaves, corn stover, etc.); (iii) agricultural residues (e.g., wheat straw, corn cobs, barley straw, corn stover, etc.); (iv) forestry material; (v) livestock manure, such as swine and cow manure; (vi) food scraps and/or agrifood processing residues (e.g., from slaughterhouse), and/or (vii) municipal waste or components removed or derived from municipal waste. These examples of suitable biomass are advantageous in that they do not compete with food production. The use of forestry or agricultural feedstocks (e.g., energy crops, residues, by products, or waste from the processing of plant material in a facility, or feedstock derived therefrom, or agricultural residues) may be advantageous for reducing GHG emissions. The use of livestock manure, such as swine or cattle manure, is particularly advantageous in terms of reducing the lifecycle GHG emissions of the hydrogen, or fuel, fuel intermediate, or chemical production produced using the hydrogen. In certain embodiments, the biomass is a fibrous biomass (e.g., straw). In certain embodiments, the biomass is waste material (e.g., manure).

The biomass is converted to the biogas using any suitable process or combination of processes. For example, the production process to produce biogas that is then, for example, upgraded partially or completely to produce the biomethane feedstock can include anaerobic digestion or gasification. The biogas thereby produced is a gas mixture that contains methane produced from biomass, among other components.

For purposes herein, “biomethane feedstock”, means biogas, renewable natural gas, or methane from renewable sources. The biomethane feedstock may be partially upgraded biogas or obtained from biogas that is upgraded so that it at least meets pipeline specifications or may also be natural gas that is treated under applicable regulations as renewable or having environmental attributes or otherwise treated as being from renewable sources (e.g., provided from a natural gas distribution system). For purposes herein, “biomethane production process” refers to one or more processes that converts biomass to biomethane feedstock.

Anaerobic digestion refers to the biological breakdown of organic matter by anaerobic microorganisms and is typically conducted in anaerobic or low oxygen conditions and may involve a series of microorganism types and processes (e.g., hydrolysis, acidogenesis, acetogenesis, and methanogenesis). In general, the anaerobic digestion of biomass can be conducted in any suitable environment, including a natural environment (e.g., a landfill) or a controlled environment (e.g., one or more anaerobic digesters arranged in series and/or in parallel). Each anaerobic digester can be a holding tank, or another contained volume, such as a covered lagoon or sealed structure, configured to facilitate the anaerobic digestion and collection of biogas. Using a controlled environment facilitates the monitoring of input and output material flows, which can be used to determine how much biogas is produced from the anaerobic digestion of a certain amount of biomass, and/or which can be used to calculate lifecycle GHG emissions and/or validate compliance (e.g., with a pathway).

The biogas typically is a gas mixture that contains methane (CH₄) and carbon dioxide (CO₂), and may further comprise water (H₂O), nitrogen (N₂), hydrogen sulfide (H₂S), ammonia (NH₃), oxygen (O₂), volatile organic compounds (VOCs), and/or siloxanes, depending on the biomass from which it is produced. The gas mixture produced from anaerobic digestion often has a methane content between about 35% and about 75% (e.g., about 60%) and a carbon dioxide content between about 15% and about 65% (e.g., about 35%). The percentages used to quantify biogas composition and/or a specific gas content, as used herein, are expressed as mol %, unless otherwise specified. More specifically, they are expressed by mole fraction at standard temperature and pressure (STP), which is equivalent to volume fraction.

As noted, the biogas produced from anaerobic digestion or gasification is generally subjected to at least partial upgrading. Such upgrading refers to a process where the gas mixture (e.g., also referred to in the art as a “raw” or “crude” biogas, or simply “biogas”) is treated to remove one or more components (e.g., CO₂, N₂, H₂O, H₂S, O₂, NH₃, VOCs, siloxanes, and/or particulates), wherein the treatment increases the calorific value of the gas mixture and produces a biomethane feedstock. For example, such upgrading typically includes removing carbon dioxide and/or nitrogen from the mixture. In general, such upgrading can be conducted using any suitable technology or combination of technologies known in the art. Such upgrading, which may be referred to as biogas upgrading or biomethane upgrading herein, and which is well-known to those of skill in the art, often includes one or any combination of absorption, adsorption, membrane separation, and cryogenic upgrading. As will be understood by those skilled in the art, the technology or combination of technologies utilized may be dependent on the composition of the gas mixture and/or how such mixture is produced. Since the gas mixture often has a significant carbon dioxide content, biogas upgrading often includes at least one system for separating methane from carbon dioxide. Without being limiting, the carbon dioxide can be removed from the gas mixture by one or any combination of absorption (e.g., water scrubbing, organic physical scrubbing, chemical scrubbing (e.g., amine)), adsorption (e.g., pressure swing adsorption (PSA), which includes vacuum PSA, or temperature swing adsorption), membrane separation (e.g., CO₂ selective membranes based on polyimide, polysulfone, cellulose acetate, polydimethylsiloxane), and cryogenic separation.

The biogas upgrading produces a biomethane feedstock that can be used to produce hydrogen in a hydrogen production facility.

### Biomethane Feedstock Having Low Carbon Intensity (CI)

The biomethane feedstock used to produce hydrogen in a hydrogen production facility in some embodiments has a carbon intensity (CI) value within a range that is between 15 gCO₂eq/MJ and −500 gCO₂eq/MJ. The biomethane feedstock used to produce hydrogen in a hydrogen production facility in some embodiments has a CI value that is lower than 15 gCO₂eq/MJ, 20 gCO₂eq/MJ, or 25 gCO₂eq/MJ, or is within a range is between 25 gCO₂eq/MJ and −500 gCO₂eq/MJ, 25 gCO₂eq/MJ and −300 gCO₂eq/MJ, −50 gCO₂eq/MJ and −250 gCO₂eq/MJ, or −75 gCO₂eq/MJ and −250 gCO₂eq/MJ.

The term “carbon intensity” or “CI” refers to the quantity of lifecycle GHG emissions, per unit of fuel energy, and is often expressed in grams of CO₂ equivalent emissions per unit of fuel (e.g., gCO₂eq/MJ or gCO₂eq/MMBTU). As will be understood by those skilled in the art, lifecycle GHG emissions and/or carbon intensity are often determined using Lifecycle Analysis (LCA), which identifies and estimates all GHG emissions in producing a fuel or product, from the growing or extraction of raw materials, to the production of the fuel or product, through to the end use (e.g., well-to-wheel). Those skilled in the art will understand that lifecycle GHG emissions and/or carbon intensity values for a given fuel or product can be dependent upon the methodology used (e.g., as required by the applicable regulatory authority).

In general, any methodology can be used to determine carbon intensity and/or lifecycle GHG emissions. However, when the hydrogen and/or fuel/product produced using the hydrogen is specially treated for meeting a certain lifecycle GHG reduction threshold under certain regulations (e.g., is treated as clean or low carbon intensity hydrogen) and/or when the method includes obtaining one or more credits for the hydrogen and/or its production, and/or for fuel, fuel intermediate, or product produced from the hydrogen, or its production, the methodology will be selected to comply with the prevailing rules and regulations in the applicable jurisdiction (e.g., relevant to desired credits).

Methodologies for calculating carbon intensities and/or lifecycle GHG emissions according to various regulatory bodies are well known in the art and can be readily calculated by those of ordinary skill in the art. For example, in certain embodiments, the carbon intensities and/or lifecycle GHG emissions are determined using a LCA model, such as the GREET model. The GREET model, which is well-known by those skilled in the art, refers to “The Greenhouse gases, Regulated Emissions, and Energy use in Technologies Model” developed at Argonne National Laboratory (ANL) (e.g., greet.es.anl.gov). In certain embodiments, the carbon intensities and/or lifecycle GHG emissions are determined based on the fuel/product being produced according to a certain pathway (e.g., a fuel pathway). For example, in certain embodiments, the carbon intensities are pathway certified carbon intensities or are regulatory default value carbon intensities. In general, the term “fuel pathway” refers to a collective set of processes, operations, parameters, conditions, locations, and technologies throughout all stages that the applicable agency considers appropriate to account for in the system boundary of a complete analysis of that fuel's lifecycle greenhouse gas emissions. In some cases, a fuel pathway can be a specific combination of three components, namely: (1) feedstock, (2) production process, and (3) product or fuel type. In certain embodiments, the carbon intensities are regulatory default value carbon intensities. For example, in the UK, biomethane produced from wet manure may have a default carbon intensity of 22 gCO2eq/MJ when the digestate is fed to an open enclosure, and when the off-gas from biogas upgrading is not combusted, or may have a default carbon intensity of −100 gCO2eq/MJ when the digestate is fed to closed enclosure, and when the off-gas from biogas upgrading is combusted. In certain embodiments, the carbon intensities (e.g., of the biomethane feedstock) are determined using disaggregated default values (e.g., associated with certain feedstocks and/or steps in a supply chain) or a mixture of disaggregated default values and measured values (e.g., based on supply chain specific measured values). In certain embodiments, the carbon intensities (e.g., of the biomethane feedstock) are determined (e.g., using an LCA) and then verified by the regulatory agency (e.g., the fuel pathway and/or corresponding carbon intensities can be approved by the regulatory agency) and/or by a verification body approved and/or appointed by the regulatory agency.

As noted above, any methodology can be used to determine the CI's (e.g., CIᵢ, CI_{T}, CI_{NRGF}, CI_{B}) and/or carbon emissions (e.g., k) in Equation A, so long as the same methodology is used for all. However, as further noted previously, in those embodiments in which the biomethane feedstock has a carbon intensity (CI) value within a designated range, e.g., that is between 15 gCO2eq/MJ and −500 gCO2eq/MJ, the GREET model is used to measure CI for purposes of determining whether the CI of the biomethane feedstock is within such designated range, regardless of what model is used to calculate CIᵢ, CI_{T}, CI_{NRGF}, CI_{B} in the Equation A. In some embodiments, when the prevailing methodology which is used to determine CIᵢ, CI_{T}, CI_{NRGF}, CI_{B} in the Equation A is not the GREET model, then the methodology for determining whether the CI of the biomethane feedstock is within a specified range will be different that the methodology used to calculate CI_{B} in the Equation A.

In certain embodiments herein, such biomethane feedstock having the foregoing CI range is referred to as a “low CI biomethane feedstock”. The CI value of such biomethane feedstock is obtained at least in part by one or any combination of:
(a) capturing and sequestering carbon dioxide generated from an anaerobic digestion that formed the biomethane feedstock;
(b) capturing and sequestering carbon from a residue of the anaerobic digestion that formed the biomethane feedstock;
(c) using a renewable energy source to power a production process for producing or upgrading the biomethane feedstock; and/or
(d) processing animal waste and avoiding emissions of methane to atmosphere that would otherwise have been released without production and collection of the biomethane feedstock.

It should be understood that the CI value of the low CI biomethane feedstock may be only partially attributed to any one of the foregoing methods to reduce CI. That is, additional steps/measures not specifically set forth above can contribute to a low CI, as would be understood by those skilled in the art. In addition, any combination of the above methods or measures to reduce CI of the biomethane feedstock can be used to achieve a desired CI associated with the biomethane feedstock. Embodiments of each of the foregoing methods are described in more detail below.

### (a) Carbon Dioxide Capture and Sequestration

Capturing and sequestering carbon dioxide generated from an anaerobic digestion that formed the biogas that is at least partially upgraded to biomethane feedstock comprises obtaining carbon dioxide, typically from a step of upgrading the biogas as described above. As discussed, the biogas produced from anaerobic digestion may have a methane content (mol %) between about 35% and about 75% (e.g., about 60%) and a carbon dioxide content between about 15% and about 65% (e.g., about 35%). The carbon dioxide can be captured from the biogas using one or more of the techniques described above in connection with biogas upgrading. The term “captured” is used herein in a non-limiting sense and includes any method, process and/or technique for obtaining carbon dioxide from a mixture of gases comprising methane (e.g., biogas), including but not limited to those methods and processes described in connection with biogas upgrading.

The carbon dioxide thus captured from biogas upgrading is sequestered. This includes any methodology for sequestration of carbon dioxide, including any storage (e.g., underground), that is carried out so that most or all of the carbon dioxide is prevented from entering the atmosphere or in which entry to atmosphere thereof is delayed. The carbon dioxide may be introduced underground in a geological formation, such as an underground reservoir that sequesters the carbon dioxide. In some non-limiting embodiments, measures may be taken to reduce leakage of carbon dioxide from the geological formation. In another non-limiting example, the carbon dioxide is sequestered in concrete by its introduction to a concrete manufacturing process using known methods. In another non-limiting example, the carbon dioxide is sequestered as a result of its use in enhanced oil recovery (EOR) or for the production of one or more products (e.g., plastics). Sequestration of carbon dioxide often includes compressing the captured carbon dioxide (e.g., to produce liquid carbon dioxide or for injection into a carbon dioxide distribution system) and transporting the captured carbon dioxide for sequestration (e.g., by vehicle and/or a carbon dioxide distribution system). As will be understood by those skilled in the art, it can be advantageous to sequester the captured carbon dioxide using a method recognized by the applicable regulatory authority for reducing GHG emissions and/or mitigating climate change. In certain embodiments, the carbon dioxide is provided for sequestration by transporting it (e.g., by pipeline or vehicle) to a carbon capture and sequestration hub or site.

(b) Capturing and Storing Carbon from Residue

In addition to producing the biomethane feedstock, the biomethane production process may produce residue that is not converted to the biomethane feedstock. Such residue comprises carbon and thus providing it, and/or material derived therefrom, for use in carbon capture and sequestration may also reduce the CI of the biomethane feedstock. The term “providing”, as used herein with respect to an element, refers to directly or indirectly obtaining the element and/or making the element available for use.

In some embodiments, the residue is a digestate from anaerobic digestion. Digestate refers to the material remaining after one or more stages of the anaerobic digestion (e.g., the term may refer to acidogenic digestate, methanogenic digestate, or a combination thereof). Digestate can include any organic material not digested by the anaerobic microorganisms, byproducts of the anaerobic digestion released by the microorganisms, and/or the microorganisms themselves. For example, the digestate can include carbohydrates, nutrients (such as nitrogen compounds and phosphates), other organics, and/or wild yeasts. The composition of digestate can vary depending on the biomass from which it is derived. Digestate in some embodiments has both a solid and liquid component. Thus, the residue can be in the form of solid, liquid and/or semi-solid material. A common use of digestate is as a soil conditioner, where it can provide nutrients for plant growth and/or displace the use of fossil-based fertilizers. In certain embodiments of the disclosure, the digestate is processed to provide carbon-containing material that that can be sequestered as part of carbon capture and sequestration. In general, one or more types of carbon-containing material containing and/or derived from at least part of the residue may be sequestered.

In certain embodiments of the disclosure, the carbon-containing material is sequestered as a liquid, semi-solid and/or solid material derived from (i.e., obtained from or produced from) a part of the biomass not converted to bioenergy. In certain embodiments, the carbon-containing material is not biodegradable under the storage conditions. In certain embodiments, the sequestration is selected such that if the carbon-containing material does degrade, that carbon dioxide released from the degradation is trapped.

In certain embodiments of the disclosure, the residue is a carbon-containing material, such as biochar. Biochar, which can be produced from gasification and/or pyrolysis of the biomass, can be recycled within the gasification and/or pyrolysis processes (e.g., to provide additional fuel for the process). Alternatively, biochar, which is biologically unavailable, can be provided as a soil amendment where it can sequester the carbon in the soil for prolonged periods of time, such as for centuries. In certain embodiments of the disclosure, the carbon sequestration includes providing biochar as a soil amendment (e.g., instead of recycling it within the process), or includes subjecting a carbon-containing material derived from the biomass and not converted to bioenergy (e.g., a portion of the digestate) to gasification and/or pyrolysis, and providing the biochar produced therefrom for soil amendment, for carbon capture and sequestration, and/or some other external use. Advantageous, such process may also produce additional bioenergy from the biomass (e.g., fuel and/or electricity). In certain embodiments, the heat and/or electricity generated from gasification and/or pyrolysis of a byproduct is used within the process (e.g., in the biomethane production process) in order to maintain the carbon intensity of the biomethane feedstock, renewable hydrogen, and/or fuel produced therefrom below a certain limit (e.g., below 20, 10 or 0 gCO2eq/MJ). In certain embodiments, the heat and/or electricity generated from combusting the biochar is used within the process (e.g., in the biomethane production process) in order to for the carbon intensity of biomethane feedstock, renewable hydrogen, and/or fuel produced therefrom to be below a certain limit (e.g., below 20, 10 or 0 gCO2eq/MJ). As will be understood by those skilled in the art, biochar produced by the pyrolysis of biomass can have properties and/or can be produced in amounts that are dependent on the temperature and/or holding times. In some cases, the biochar can be coal-like and/or have an energy density that is similar or higher than fossil-based coal. Combusting biochar can offset fossil-based coal, thereby further reducing the carbon intensity of biomethane feedstock, renewable hydrogen, and/or fuel produced therefrom.

In certain embodiments of the disclosure, the residue includes digestate from anaerobic digestion, and carbon dioxide produced from processing at least part of the digestate is sequestered. For example, in certain embodiments, at least part of the digestate, or a stream derived therefrom, is subjected to combustion, gasification and/or pyrolysis. Such processes, which can also produce heat and/or power for the process, typically produce carbon dioxide that can be captured. For example, carbon dioxide can be captured from flue gas produced from the combustion of digestate, pyrolysis oil, char, and/or syngas (e.g., produced from gasification or pyrolysis), or can be captured from the syngas (e.g., pre-combustion). In certain embodiments, the digestate is dried prior to combustion, gasification and/or pyrolysis (e.g., at least partially dried via solid-liquid separation and/or thermal drying). In certain embodiments, the digestate, or a stream derived therefrom, is processed with fossil fuels. For example, pyrolysis oil may be converted to electrical power through co-combustion in a conventional fossil fuel power plant.

When carbon dioxide is captured from such processes (e.g., from flue gas and/or syngas), more biogenic carbon from the biomass can be sequestered, thereby further reducing the carbon intensity of the resulting biomethane feedstock and/or fuel or product produced therefrom (e.g., hydrogen and/or ammonia). Without being limiting in any way, and depending on the feedstock and/or process, about 50% of the carbon from the original biomass may end up in the biogas (e.g., as CO₂ and CH₄) while about 50% may end up in the digestate. Accordingly, sequestering both carbon dioxide from the biogas and carbon dioxide derived from the digestate (e.g., produced from combusting the digestate) can significantly decrease the carbon intensity of the biomethane feedstock and/or result in a substantial amount of carbon originally present in the biomass being converted to energy and/or used to reduce greenhouse gas emissions.

In certain embodiments, the residue includes digestate from anaerobic digestion, and carbon dioxide produced from combusting at least part of the digestate (e.g., the solids) is sequestered. For example, in such embodiments, the digestate from anaerobic digestion can be subjected to a solids-liquid separation (e.g., using a screw press and/or centrifuge), the resulting solids stream may be dried (e.g., at least partially dried via additional solid-liquid separation and/or thermal drying), the digestate can be combusted (e.g., fed to an incinerator), and carbon dioxide generated from the combustion of the digestate can be captured from the flue gas and provided for sequestration. Optionally, the digestate may be subjected to compression (e.g., formed into bales, pellets, or brickettes) prior to combustion. Such embodiments are advantageous in that the combustion of at least part of the digestate can generate heat and/or power for the process (e.g., without requiring a substantial about of additional heat and/or power). One advantage of subjecting digestate to combustion is that the upstream processing may result in fewer alkali salts (e.g., potassium salts) being present during the combustion (e.g., relative to combustion of raw biomass). In certain embodiments, at least part of the digestate is combusted with another feedstock (e.g., wood chips).

In certain embodiments, the residue includes digestate from anaerobic digestion, and carbon dioxide produced from the gasification or pyrolysis of at least part of the digestate (e.g., the solids) is sequestered. For example, in such embodiments, the digestate from anaerobic digestion can be subjected to a solids-liquid separation (e.g., using a screw press and/or centrifuge), the resulting solids stream may be dried (e.g., at least partially dried via additional solid-liquid separation and/or thermal drying), the digestate can be gasified to produce syngas, and carbon dioxide from the syngas can be captured (e.g., pre- or post combustion of the syngas) and provided for sequestration. Optionally, the digestate may be subjected to compression (e.g., formed into bales, pellets, or brickettes) prior to gasification. Such embodiments can be advantageous in that combustion of at least part of the syngas (e.g., the hydrogen) can produce heat and/or power for the process, that such electric power can be generated in engines and/or gas turbines (e.g., which may be cheaper and more efficient that the steam cycle used in incineration) or in fuel cells, and that the carbon dioxide can be captured from the syngas (i.e., pre-combustion). Capturing carbon dioxide from the syngas can be advantageous, at least because the syngas can be at higher pressure than flue gas (e.g., from incineration).

In certain embodiments of the disclosure, the carbon sequestration includes storing carbon in a product. In this case, a carbon-containing material derived from the biomass and not converted to bioenergy is used to produce a product that makes the carbon unavailable for biodegradation (e.g., can be provided in products that provide continued sequestration benefits, such as building materials).

In certain embodiments of the disclosure, the sequestration includes sequestering liquid, semi-solid and/or solid carbon-containing material derived from the residue. In some embodiments, the material is sequestered indefinitely in a subsurface formation. For example, the digestate can be subjected to a hydrothermal liquefaction to provide a bio-oil that can be sequestered. The pyrolysis of biomass, which can be part of biomethane production, can also produce pyrolysis oil, which can be sequestered. In some cases, the sequestration method is selected to prevent biodegradation of the material and/or trap GHGs in the event of biodegradation. In some embodiments, the material is treated in a process to reduce the potential for biodegradation. Sequestering a liquid carbon-containing material derived from the biomass may be advantageous in that injection into the storage area may be feasible and/or there may be fewer concerns related to leakage (i.e., relative to carbon dioxide sequestration).

### (c) Using a Renewable Energy Source or Low-Carbon Electricity to at Least Partially Power the Biomethane Production Process

In certain embodiments of the disclosure, energy for the biomethane production process is generated using a renewable energy source, such as low-carbon electricity. Low-carbon electricity refers to electricity generated in a process that does not emit significant amounts of fossil-based carbon dioxide and/or is produced from renewable energy sources. Without being limiting, low-carbon electricity can include electricity produced using nuclear power, hydropower, solar power, wind power, geothermal power, wave power, tidal power, or electricity produced from the combustion of a low-carbon energy source (e.g., biomass, biogenic syngas, or hydrogen) or of a fossil-based energy source with carbon capture and sequestration (CCS). In certain embodiments of the instant disclosure, heat required for the biogas upgrading is generated using renewable electricity (i.e., electricity produced using renewable energy sources such as hydropower, solar power, wind power, geothermal power, wave power, tidal power, etc.). In certain embodiments, heat and/or low-carbon electricity for the biomethane production process is generated from gasification of agricultural and/or solid waste. In certain embodiments, heat and/or low-carbon electricity for the biomethane production process is generated from gasification and/or pyrolysis of residue (e.g., dried digestate). In certain embodiments, heat and/or low-carbon electricity for the biomethane production process is generated from combustion, gasification, or pyrolysis of carbon-containing material obtained or derived from the residue (e.g., combustion of biochar, pyrolysis of bio-oil, etc.).

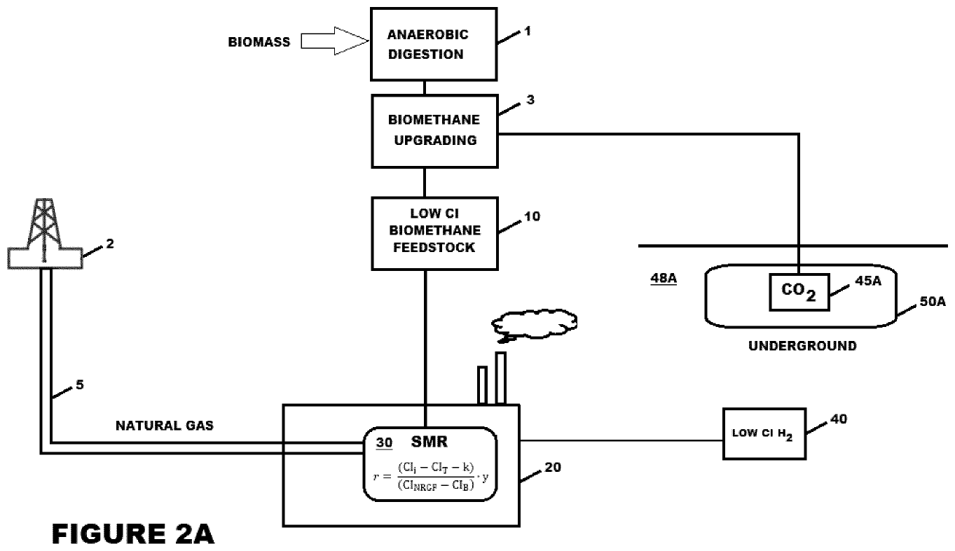

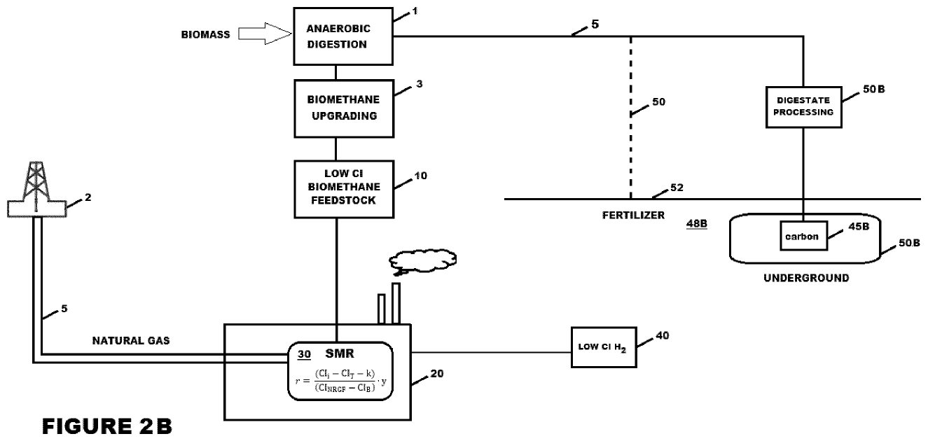

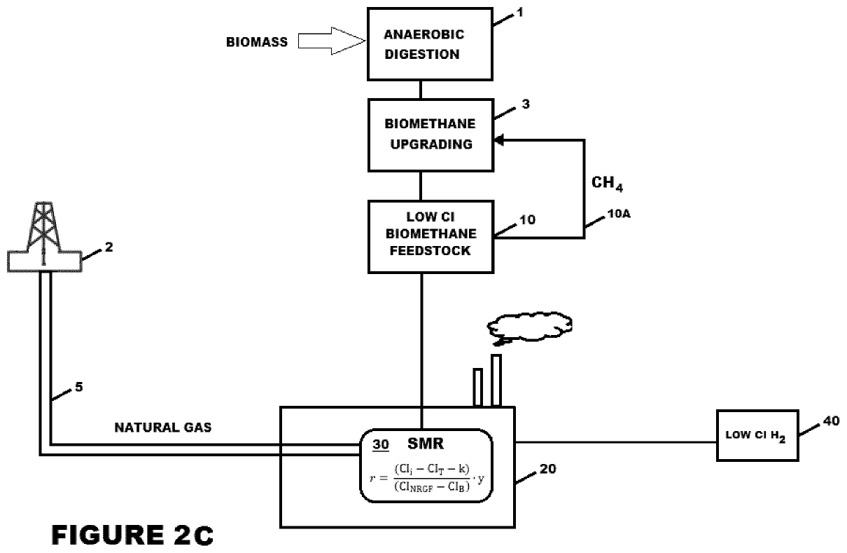

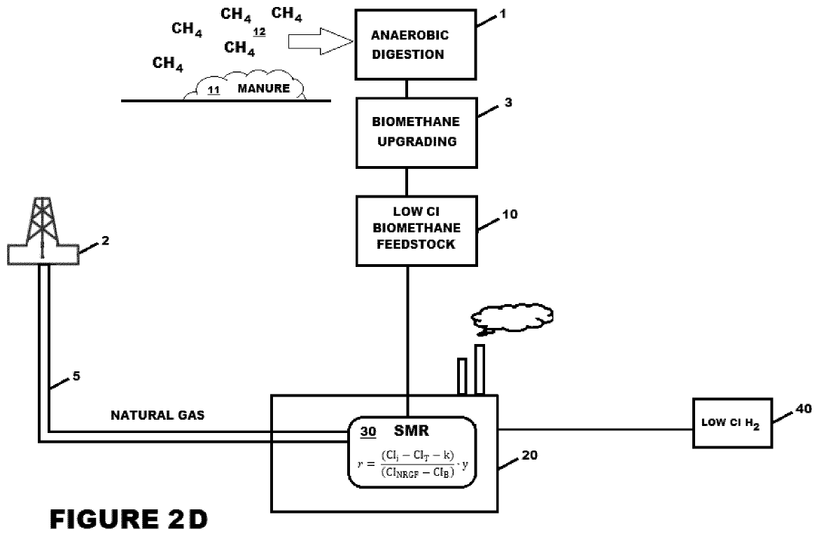

In certain embodiments, biogas that is at least partially upgraded can be used to generate electricity for the biomethane production process. For example, a portion of the low CI biomethane feedstock may be recycled to the biogas upgrading to generate electricity for the biogas upgrading. A non-limiting example is depicted in FIG. 2C hereinafter.

In general, the CI of a biomethane feedstock can be reduced as a result of using low-carbon electricity in any of one or more points of the biomethane production process (e.g., reduced relative to using electricity generated from fossil fuels). For example, low-carbon electricity can be used at any point in the anaerobic digestion and/or biogas upgrading.

In certain embodiments, the low-carbon electricity is used for one or more pumps and/or compressors, for stirring, and/or for heating in the anaerobic digestion. For example, manure-based feedstock is often pumped as a slurry into one or more anaerobic digesters, which are at least periodically stirred throughout the anaerobic digestion, and which are often heated to maintain a suitable temperature (i.e., suitable for facilitating anaerobic digestion).

In certain embodiments, the low-carbon electricity is used for one or more pumps and/or compressors used in the biomethane production process. For example, biogas is often compressed prior to and/or in intermediate stages of membrane separations, PSA separations, and absorption separations. In addition, the biomethane feedstock produced may be compressed for transport to the hydrogen production (e.g., compressed to pipeline pressure and/or for transport in compressed natural gas (CNG) trailers).

While using a renewable energy source, such as low-carbon electricity, to at least partially power the biomethane production process can help reduce the carbon intensity of the biomethane feedstock, renewable hydrogen, fuel and/or product produced therefrom, it can be advantageous when the low-carbon electricity is generated at least in part from the combustion, gasification, and/or pyrolysis of biomass (e.g., digestate from anaerobic digest and/or some other feedstock such as woodchips). For example, subjecting at least part of the digestate to combustion, gasification, and/or pyrolysis can harness additional energy from the original biomass, while also produces renewable heat and/or power for the process. In certain embodiments, at least part of the digestate produced as a byproduct from the biomethane production process, or a stream derived therefrom is subjected to combustion, gasification and/or pyrolysis. Such processes may: 1) generate heat that can be used in the process, or 2) use heat, an excess of which may be used in the process. In addition, subjecting biomass (e.g., digestate from anaerobic digest and/or some other feedstock such as woodchips) to combustion, pyrolysis, and/or gasification for producing heat and/or power can generate gas containing carbon dioxide that can be captured and sequestered to further reduce the carbon intensity of the biomethane feedstock, renewable hydrogen, and/or fuel or product produced therefrom. In certain embodiments, at least a portion (e.g., all) of the carbon dioxide from the gas produced from the combustion, gasification, and/or pyrolysis is captured and provided for sequestration.

(d) Processing Animal Waste and/or Food Waste and Avoiding Emissions of Methane

In certain embodiments, when the biomass is animal waste, methane emissions from such animal waste may be captured rather than allowed to enter the atmosphere. For example, in swine and/or dairy operations, manure is often sent to a pit or other containment area and methane emitted therefrom (among other gases) enters the atmosphere. Methane may also enter the atmosphere at other stages of an animal waste management process, including the spreading of manure on fields to fertilize crops.

In certain embodiments, the animal waste is sent to an anaerobic digestion from which biogas is collected. The closed or substantially closed environment of the anaerobic digester or digesters aids in a reduction of biomethane emissions that would otherwise be emitted to the atmosphere. Such containment may also aid in the reduction of NOx emissions to atmosphere, among other volatile gases produced from the animal waste. Any suitable method for collecting the biomethane may be employed, including a partially contained area to collect the methane.

The animal waste may originate from one or any combination of different sources, including slaughterhouse waste, restaurant waste containing animal products, manure from a variety of farming operations, including but not limited to waste from dairy operations, feedlots for raising beef or dairy cattle for meat production, chicken waste, hog waste or any combination thereof. In certain embodiments, the biomass is dairy and/or swine manure.

In certain embodiments, the animal waste, such as manure, has a suitable consistency such that it can be pumped to facilitate its introduction to one or more anaerobic digestors. The manure may be stored in a closed pit or other containment means prior to collection of the biomethane feedstock.

An operation that produces animal waste may introduce the biomethane feedstock produced and collected from the animal waste to a pipeline (after suitable upgrading), such as a natural gas pipeline or otherwise transport the biomethane feedstock off-site. In another embodiment, part of the biomethane feedstock is used on-site, such as but not limited to producing electricity and/or heat for a farming or other operation. For example, without being limiting, at least part of the biomethane feedstock may be used in a combined heat and power (CHP) engine or otherwise used to generate electricity for use in the operation. In another embodiment, at least part of the biomethane feedstock is used both on-site and sent off-site for other uses, such as to heat homes or to make fuel therefrom.

In certain embodiments, waste other than animal waste is processed, and methane emissions from such waste are captured rather than allowed to enter the atmosphere. For example, in certain embodiments food waste (e.g., source separated organics) is subjected to anaerobic digestion in a production process that produces the biomethane feedstock. Advantageously, diverting the food waste from a landfill, where methane (among other gases) may be emitted and released to the atmosphere, and/or collecting biogas produced from the anaerobic digestion of the food waste, may qualify the biomethane feedstock and/or fuel, fuel intermediate, or product produced therefrom for incentives associated with avoided emissions of methane (e.g., a reduced carbon intensity, or incentives associated therewith) under certain government programs.

### Hydrogen Production

The biomethane feedstock is provided at a hydrogen production facility and is used to replace a fraction of a non-renewable gaseous feedstock. The “hydrogen production facility” as used herein includes any unit operation(s) that makes hydrogen regardless of its location or proximity to another facility or unit operation(s) that uses such hydrogen produced in such facility. The hydrogen produced in such facility can be purified therein or sent to another unit operation(s) or process that removes unwanted components therefrom. Without limitation, the hydrogen production facility includes any unit operation or operations within or in proximity to another facility or plant, such as an oil refinery or an ammonia or fertilizer production plant, or the like, or a stand-alone facility that produces hydrogen as a product or as an intermediate to make another product, including a fuel. Additional examples are readily conceivable by those of skill in the art and accordingly the term is not to be construed as limited to the examples described herein or any particular type of hydrogen production facility.

The hydrogen production facility uses non-renewable gaseous feedstock and a fraction of the non-renewable gaseous feedstock is replaced by the biomethane feedstock. This includes replacement of a fraction of the non-renewable gaseous feedstock with methane that is considered renewable by regulators as described above and thus considered a biomethane feedstock as used herein.

In general, the hydrogen production in the hydrogen production facility can use any suitable technology known in the art that can convert the biomethane feedstock and/or non-renewable gas feedstock (e.g., natural gas) to hydrogen. Examples of technologies that may be suitable include, but are not limited to, steam methane reforming (SMR), autothermal reforming (ATR), partial oxidation (POX), and dry methane reforming (DMR). SMR, ATR, and DMR, which are types of catalytic reforming, may operate by exposing natural gas to a catalyst at high temperature and pressure to produce syngas. POX reactions, which include thermal partial oxidation reactions (TPOX) and catalytic partial oxidation reactions (CPOX), may occur when a sub-stoichiometric fuel-oxygen mixture is partially combusted in a reformer. POX also may be referred to as oxidative reforming. For purposes herein, the term “methane reforming” may refer to SMR, ATR, DMR, or POX. Methane reforming is well known in art and, of the various types of methane reforming, SMR is the most common.

The syngas produced from methane reforming may be further reacted in a water gas shift (WGS) reaction, wherein carbon monoxide is converted to carbon dioxide and hydrogen:

CO+H₂O→CO₂+H₂+small amount of heat

Although optional, providing a WGS downstream of methane reforming increases the yield of H₂, and thus is commonly included in hydrogen production. When included, the WGS is considered to be part of the methane reforming herein. The syngas produced from methane reforming often includes hydrogen, methane, carbon monoxide, carbon dioxide and water vapour. As will be understood by those skilled in the art, methane reforming can be conducted using one or more reactors. For example, the WGS can be conducted using a high temperature WGS reactor followed by a low temperature WGS reactor.

In certain embodiments, carbon dioxide produced from hydrogen production is sequestered as part of CCS. Without being limiting in any way, and depending on the specific process, about 40% of the carbon dioxide generated from SMR based hydrogen production may be generated in the reformer furnace (e.g., and thus captured from the flue gas), while about 60% is generated within the reforming reactor(s) (e.g., and thus can be captured from the syngas or a stream derived from the syngas, such as off-gas from hydrogen purification). When the hydrogen purification includes PSA, and when off-gas from the PSA (e.g., purge gas) is recycled such that it combusted in the reformer furnace to generate heat for the reforming, the carbon dioxide generated within the reforming reactors can also be captured from the flue gas (e.g., such that all of the carbon dioxide captured from hydrogen production is captured from the flue gas). Since the flue gas, syngas, and/or off-gas typically are at different pressures and/or have different compositions, including different carbon dioxide partial pressures, the choice of capture technology and/or process conditions may be dependent on the selected stream. For example, when a gas stream has a very high carbon dioxide concentration, carbon capture by amine solution may be energy intensive (e.g., related to the energy consumption for solvent regeneration). In certain embodiments, carbon dioxide is captured from the syngas using one or more adsorption technologies (e.g., PSA and/or vacuum PSA (VPSA)) and/or one or more absorption technologies (e.g., an absorption amine unit). In certain embodiments, carbon dioxide is captured from flue gas using one or more absorption technologies (e.g., chemical absorption that uses an amine solvent (e.g., an activated amine process). When carbon dioxide is captured from both the flue gas and syngas (or off-gas) using amine absorption, the two separations may use different solvents. Without being limiting in any way, in some embodiments, it may be more technically and/or economically more feasible to capture the carbon dioxide from the syngas and/or off-gas, as the flue gas may have a relatively low carbon dioxide concentration, may be at a lower pressure (e.g., atmospheric), and/or is often contaminated with nitrogen.

In certain embodiments, renewable power is used to at least partially power the hydrogen production. For example, renewable power can be used to provide at least some of the heat for methane reforming, for producing steam, for hydrogen purification, and/or for compression of the hydrogen product.

Replacing a Fraction of Non-Renewable Gaseous Feedstock with the Biomethane Feedstock

The non-renewable gaseous feedstock replaced at the hydrogen production facility is feedstock that is (a) fed to methane reforming; and/or (b) used to generate heat for the reforming in the hydrogen production. The non-renewable gaseous feedstock may be natural gas, refinery gas, liquid petroleum gas (LPG), light naphtha, heavy naphtha and straight-run naphtha or any other suitable non-renewable feedstock used in hydrogen production facilities known to those of skill in the art. In certain embodiments, the non-renewable gaseous feedstock that is replaced is natural gas.

The biomethane feedstock may be used to replace any non-renewable gaseous feedstock fed to methane reforming, including but not limited to any reforming process comprising SMR, ATR, and/or DMR as described previously.

The biomethane feedstock may be alternatively or additionally used to replace a fraction r of any non-renewable feedstock used to generate heat for reforming. This can include replacing a non-renewable gaseous feedstock combusted in reformer burners. In one non-limiting example, a combustion chamber may surround the reformer tubes that contains the catalyst and in which the reforming reaction is conducted. For example, in steam methane reforming, a preheated feed stream of the non-renewable gaseous feedstock may be fed, along with steam, into reactor tubes for the methane reforming, which contain a reforming catalyst. Streams of natural gas and combustion air may be fed into the reformer burners, which provide the heat (e.g., required for an endothermic reforming reaction). The syngas produced from the methane reforming may be fed to WGS to produce more hydrogen. In some embodiments, the feed can include natural gas in addition to biomethane feedstock when the biomethane feedstock is used to replace a fraction of the natural gas as described hereinafter. The reformers may be characterized by the location of the burners within the combustion chamber (e.g., side-fired, top-fired, bottom-fired). As a skilled addressee would appreciate, such fired burners are commonly used in hydrogen production that includes steam methane reforming.

Replacing a fraction of the non-renewable gaseous feedstock with biomethane feedstock can be based on allocating the biomethane feedstock and/or physically directing it (e.g., feeding biomethane feedstock into the SMR tubes and/or the SMR burners).

In certain embodiments, heat required for the reforming is at least partially provided by direct electrical resistance, inductive heating or by using a heat storage medium. As would be appreciated by those of skill in the art, various methods can be used to provide heat to reforming and biomethane feedstock can be used directly or indirectly to replace any non-renewable gaseous feedstock used in such heating processes.

In certain embodiments, the fraction of non-renewable gaseous feedstock replaced by the biomethane feedstock is defined by r, which is determined by Equation A below:

$$r = \frac{( {CI}_{i} - {CI}_{T} - k - {C}_{r} )}{( {CI}_{NRGF} - {CI}_{B} )} \cdot y , \qquad Equation A$$

wherein the CI values of Equation A are expressed in gCO₂eq/MJ.

The CIᵢ is a calculated carbon intensity of the hydrogen produced by reforming assuming only the use of a non-renewable gaseous feedstock in the absence of carbon capture and sequestration and without using renewable power for the hydrogen production. In such a process, only non-renewable gaseous feedstock is assumed to be used in reforming (i.e., without replacement by the biomethane).

The CI_{T} is the target carbon intensity of the hydrogen to be produced in the hydrogen production facility. The target carbon intensity CI_{T} may correspond to or be set in accordance with achieving some predetermined carbon intensity threshold (e.g., under which it is treated as clean or low carbon hydrogen) and/or may correspond to or be set in accordance with achieving a carbon intensity associated with a predetermined lifecycle GHG reduction (e.g., a value set by regulations or otherwise measured relative to CIᵢ, (CIᵢ−k), (CIᵢ−k−Cᵣ) and/or to a baseline value (e.g. a fossil baseline) as determined by applicable regulations).

In certain embodiments, the target carbon intensity CI_{T} is a predetermined carbon intensity threshold. For example, in some embodiments, the target carbon intensity is a carbon intensity determined using GREET that is less than or equal to about 60 gCO₂eq/MJ, less than or equal to about 50 gCO₂eq/MJ, less than or equal to about 40 gCO₂eq/MJ, less than or equal to about 30 gCO₂eq/MJ, less than or equal to about 20 gCO₂eq/MJ, less than or equal to about 15 gCO₂eq/MJ, less than or equal to about 10 gCO₂eq/MJ, less than or equal to about 8 gCO₂eq/MJ, less than or equal to about 6 gCO₂eq/MJ, less than or equal to about 5 gCO₂eq/MJ, less than or equal to about 4 gCO₂eq/MJ, less than or equal to about 2 gCO₂eq/MJ, or less than or equal to about 0 gCO₂eq/MJ. For example, it may be advantageous to meet a target carbon intensity of 0 (i.e., a carbon intensity that is equal to or less than zero) as it can produce zero-emission hydrogen or hydrogen having a negative carbon intensity. In some embodiments, the target carbon intensity is a carbon intensity determined using GREET that is less than or equal to about −10 gCO₂eq/MJ, less than or equal to about −20 gCO₂eq/MJ, or less than or equal to about −30 gCO₂eq/MJ.

In some embodiments, the target carbon intensity CI_{T} is a carbon intensity that reflects a certain lifecycle GHG reduction (e.g., measured relative to CIᵢ−k−Cᵣ, or to a baseline value (e.g., a fossil baseline)). For example, in some embodiments, the target carbon intensity is a carbon intensity that reflects a lifecycle GHG reduction that is at least about 40%, at least about 50%, at least about 60%, at least about 70%, at least about 80%, at least about 90%, or at least about 95% relative to CIᵢ. In some embodiments, the target carbon intensity is a carbon intensity that reflects a lifecycle GHG reduction that is at least about 40%, at least about 50%, at least about 60%, at least about 70%, at least about 80%, at least about 90%, or at least about 95% relative to CIᵢ−k−Cᵣ. For example, the initial CIᵢ may be between about 80 gCO₂eq/MJ and about 130 gCO₂eq/MJ, depending upon the hydrogen production and/or methodology used to calculate carbon intensity. For a lifecycle GHG reduction that corresponds to 70% relative to CIᵢ, the corresponding CI_{T} would be between about 24 gCO₂eq/MJ and about 39 gCO₂eq/MJ. If the hydrogen production includes carbon capture and sequestration, where k=60 gCO₂eq/MJ, but does not use renewable power for the hydrogen production, then for a lifecycle GHG reduction that corresponds to 70% relative to CIᵢ−k−Cᵣ, the corresponding CI_{T} would be between about 6 gCO₂eq/MJ and about 21 gCO₂eq/MJ.

In some embodiments, the low CI H₂ and/or its production is associated with at least a 70% reduction in carbon emissions relative to the hydrogen production facility using only the non-renewable gaseous feedstock. In such embodiments, the at least 70% reduction in carbon emissions is measured relative to CIᵢ and in which k or Cᵣ (defined above in Equation A and described below) emission savings are subtracted if carbon capture and sequestration and/or renewable power are used in the hydrogen production facility (k and Cᵣ are zero when neither are used) (i.e., percent reduction is measured relative to CIᵢ−k−Cᵣ).

In some embodiments, the target carbon intensity is a carbon intensity that reflects a lifecycle GHG reduction that is at least about 40%, at least about 50%, at least about 60%, at least about 70%, at least about 80%, at least about 90%, or at least about 95% relative to a fossil baseline set by regulators. With regard to the latter, consider the case where the fossil comparator for hydrogen production is 94 gCO₂eq/MJ. When the goal is to achieve a 95% GHG reduction, the target CI may be about 4.7 gCO₂eq/MJ. However, other CI_{T} targets may be encompassed within the scope of the disclosure as well.

In certain embodiments, the hydrogen production and/or the hydrogen itself is associated with a lifecycle GHG reduction corresponding to at least 60%, at least 70%, at least 80%, at least 90%, or at least 95%, relative to a baseline value set by regulators (e.g., a fossil baseline corresponding to the production of hydrogen by steam methane reforming non-renewable natural gas). Such embodiments may be advantageous because under certain government programs tax benefits may be tied to the level of GHG reductions relative to a fossil hydrogen baseline.

The k of Equation A is the net amount of carbon dioxide captured and sequestered per unit of hydrogen produced in gCO₂eq/MJ associated with hydrogen production. As noted above, the carbon dioxide is a byproduct of SMR and can be captured, purified, and/or transported for being introduced and sequestered (e.g., underground). The net amount accounts for both the amount of carbon dioxide captured and sequestered and the amount of carbon dioxide emitted as a result of the carbon capture and sequestration. It will be noted that k is zero when no carbon dioxide is captured and sequestered.

The Cᵣ of Equation A is carbon dioxide emissions reduction per unit of hydrogen produced in gCO₂eq/MJ attributable to using renewable power in or associated with hydrogen production. It will be noted that Cᵣ is zero when no renewable power is used in hydrogen production.

The CI_{NRGF} is the carbon intensity of the non-renewable gaseous feedstock (NRGF) fed to the hydrogen production facility. For example, this may be the non-renewable gaseous feedstock fed to the SMR and/or used to generate heat for the SMR as described above.

The CI_{B} is the carbon intensity of biomethane feedstock fed to the hydrogen production facility.

The y of Equation A is a ratio of energy of the hydrogen produced in MJ to the sum of energy of the non-renewable gaseous feedstock in MJ and energy of the biomethane feedstock in MJ.

The CI values are calculated based on prevailing rules and regulations. A non-limiting example of a calculation of r using Equation A is provided in Example 2 hereinafter.

As discussed herein, the term “r”, refers to the fraction of non-renewable gaseous feedstock replaced by the biomethane feedstock. More specifically, it refers to the energy of biomethane feedstock provided (e.g., in MJ) to produce a given quantity of hydrogen divided by the total energy of the feedstock provided (i.e., MJ of biomethane feedstock and MJ of non-renewable gaseous feedstock) to produce the given quantity of hydrogen. The fraction of non-renewable gaseous feedstock replaced by the biomethane feedstock corresponds to the biomethane share of gas flow. The biomethane share of gas flow, which is calculated on an energy basis, and which may be expressed as a percentage, refers to the fraction/percentage of the total energy of gaseous feedstock provided for hydrogen production that is associated with biomethane feedstock. The terms share and/or fraction do not imply that the biomethane and non-renewable gaseous feedstock are provided simultaneously, but rather refers to the share and/or fraction of the total energy provided over a given time period. For example, a batch of biomethane may be sourced and allocated to a fraction of the feedstock used to produce the quantity of hydrogen.

In certain embodiments, the fraction of non-renewable gaseous feedstock replaced by the biomethane feedstock is equal to or greater than r, where r is determined by Equation A below, and is less than or equal to about 50% (e.g., less than about 45%, about 40%, about 30%, or about 25%).

$$r = \frac{( {CI}_{i} - {CI}_{T} - k - {C}_{r} )}{( {CI}_{NRGF} - {CI}_{B} )} \cdot y , \qquad Equation A$$

wherein the CI values of Equation A are expressed in gCO₂eq/MJ. It is remarkable that the fraction of the non-renewable gaseous feedstock replaced by the biomethane feedstock can be within this relatively small range, and in particular, be less than or equal to about 25%, about 30%, about 40%, about 45%, or about 50%, and that the resulting hydrogen and/or its production can be associated with at least an about 70% reduction in carbon emissions relative to the hydrogen production using only the non-renewable gaseous feedstock (i.e., relative to CIᵢ−k−Cᵣ).

### Use of Hydrogen Produced in the Hydrogen Production Facility

In certain embodiments of the disclosure, the hydrogen is used in the hydroprocessing (e.g., hydrocracking and/or hydrotreating) of crude-oil derived liquid hydrocarbon such that the hydrogen (i.e., at least the renewable hydrogen) is incorporated into a crude-oil derived liquid hydrocarbon to produce fuel, for example, gasoline, diesel, and/or jet fuel having renewable content (e.g., see U.S. Pat. Nos. 8,658,026, 8,753,854, 8,945,373, 9,040,271, 10,093,540, 10,421,663 10,723,621 and 10,981,784, which are incorporated herein by reference). The term “crude oil derived liquid hydrocarbon”, as used herein, refers to any carbon-containing material obtained and/or derived from crude oil that is liquid at standard ambient temperature and pressure. The term “crude oil”, as used herein, refers to petroleum extracted from geological formations (e.g., in its unrefined form). Crude oil includes liquid, gaseous, and/or solid carbon-containing material from geological formations, including oil reservoirs, such as hydrocarbons found within rock formations, oil sands, or oil shale. The term “renewable content”, as used herein, refers to the portion of the fuel(s) that is recognized and/or is treated as renewable (e.g., a biofuel) under applicable regulations. As will be understood by those skilled in the art, the quantification of the renewable content can be determined using any suitable method and is typically dependent upon the applicable regulations.

In certain embodiments, the hydrogen is used to produce ammonia in a Haber-Bosch process. In the Haber-Bosch process, which is well-known to those skilled in the art, nitrogen is converted to ammonia according to the following reaction:

N₂+3H₂→2NH₃

The reaction is conducted under high temperatures and pressures with a metal catalyst. Ammonia has an important role in the agricultural industry for production of fertilizers. Ammonia may also be used as an energy carrier for energy storage and transportation.

In certain embodiments of the disclosure, the hydrogen is provided as a product (e.g., for use in a fuel cell or a fuel). For example, the hydrogen can be used for transportation purposes, for generating electricity, and/or for use in district heating.

In certain embodiments of the disclosure, the hydrogen is provided as feedstock in a production process that produces a fuel, fuel intermediate, chemical product, or any combination thereof. A fuel refers to a material (e.g., solid, liquid, or gaseous), which may contain carbon, that can be combusted to produce power or heat (e.g., may be a transportation or heating fuel). A fuel intermediate is a precursor used to produce a fuel by a further conversion process, such as by a biologic conversion, a chemical conversion, or a combination thereof. A chemical product refers to a chemical compound used in a production process or a product such as a commodity. An example of a chemical product produced from hydrogen is fertilizer.

In certain embodiments of the disclosure, the hydrogen is provided as feedstock to produce a fuel selected from long-haul trucking fuel (e.g., diesel), shipping fuel (e.g., heavy fuel oil), aviation fuel (e.g., kerosene, jet fuel) or district heating fuel. In certain embodiments of the disclosure, the hydrogen is provided as feedstock to produce fuels or chemical products such as ammonia or fertilizer.

In certain embodiments of the disclosure, the hydrogen is used to produce one or more alcohols via gas fermentation using known processes. In gas fermentation, which is well-known to those skilled in the art, a gas mixture typically containing hydrogen with carbon dioxide and/or carbon monoxide is fed into a fermentation tank. In this embodiment, the carbon monoxide in the syngas functions as a substrate for the biologic conversion, which utilizes microorganisms or other biocatalysts. For example, acetogenic microorganisms can be used to produce a fermentation product from carbon monoxide. The production of ethanol by the acetogenic microorganisms proceeds through a series of biochemical reactions.

In certain embodiments of the disclosure, the hydrogen is used to produce methanol. For example, methanol can be produced by directly hydrogenating pure carbon dioxide with hydrogen with Cu/ZnO-based catalysts. Alternatively, hydrogen can be used to produce methanol according to the following reactions:

CO₂+H₂→CO+H₂O (reverse water gas shift)

CO+2H₂→CH₃OH

The methanol can be used as a fuel (e.g., mixed with gasoline) or can be used to produce a fuel (e.g., biodiesel).

In certain embodiments of the disclosure, the hydrogen is used to produce gasoline, diesel, or waxes using the Fischer-Tropsch process. The Fischer-Tropsch process refers to a collection of chemical reactions that converts syngas into liquid hydrocarbons, typically in the presence of metal catalysts under elevated pressures and temperatures. The Fischer-Tropsch process is well known. In the embodiments including a Fischer-Tropsch process, the hydrogen may be used to supplement another gas feed containing carbon monoxide and/or carbon dioxide in order to provide the required H₂:CO (e.g., about 2).

While producing a hydrogen product, and in particular a renewable hydrogen product, is advantageous, it is particularly advantageous when the renewable hydrogen is used as feedstock for a production process (e.g., to produce a fuel, fuel intermediate, or chemical product). It can be particularly advantageous when the renewable hydrogen is used as feedstock for producing a transportation fuel. Using the renewable hydrogen in a production process can reduce GHG emissions associated with production process, and when the production process produces a fuel, can impart renewable content to the fuel and/or reduce the carbon intensity of the fuel. The GHG reductions can be significant, particularly when the renewable hydrogen has a negative carbon intensity. It can be particularly advantageous to use the renewable hydrogen in the production of ammonia and/or fertilizer, as reducing the amount of carbon dioxide produced during ammonia manufacturing may significantly contribute to achieving net-zero targets.

### Obtaining Credits

In certain embodiments of the disclosure, the process includes generating, obtaining, or providing credits. Credits are used to incentivize renewable fuels, often in the transportation sector. For example, credits, such as fuel credits, can be used to demonstrate compliance with some government initiative, standard, and/or program, where the goal is to reduce GHG emissions (e.g., reduce carbon intensity in transportation fuels as compared to some baseline level related to conventional petroleum fuels) and/or produce a certain amount of biofuel (e.g., produce a mandated volume or a certain percentage of biofuels). The target GHG reductions and/or target biofuel amounts may be set per year or for a given target date. Some non-limiting examples of such initiatives, standards, and/or programs include the Renewable Fuel Standard Program (RFS2) in the United States, the Renewable Energy Directive (RED II) in Europe, the Fuel Quality Directive in Europe, the Renewable Transport Fuel Obligation (RTFO) in the United Kingdom, and/or the Low Carbon Fuel Standards (LCFS) in California, Oregon, or British Columbia). Credits can also be used to incentivize other products associated with reduced carbon or greenhouse gas emissions, such as for example, producer or production credits for clean hydrogen or credits for products made using clean hydrogen.

The term “credit”, as used herein, refers to any rights or benefits relating to GHG or carbon reduction including but not limited to rights to credits, revenues, offsets, GHG gas rights, tax benefits, government payments or similar rights related or arising from emission reduction, trading, or any quantifiable benefits (including recognition, award or allocation of credits, allowances, permits or other tangible rights), whether created from or through a governmental authority, a private contract, or otherwise. A credit can be a certificate, record, serial number or guarantee, in any form, including electronic, which evidences production of a quantity of hydrogen or fuel meeting certain life cycle GHG emission reductions relative to a baseline (e.g., a gasoline baseline) set by a government authority. Credits for low CI hydrogen may be set by regulatory authority and provided in many forms, e.g., producer credits and the like. Non-limiting examples of fuel credits include RINs and LCFS credits. A Renewable Identification Number (or RIN), which is a certificate that acts as a tradable currency for managing compliance under the RFS2, may be generated for each gallon of biofuel (e.g., ethanol, biodiesel, etc.) produced. A Low Carbon Fuel Standard (LCFS) credit, which is a certificate which acts as a tradable currency for managing compliance under California's LCFS, may be generated for each metric ton (MT) of CO₂ reduced.

In general, the requirements for generating or causing the generation of credits can vary by country, the agency, and or the prevailing regulations in/under which the credit is generated. In many cases, credit generation may be dependent upon a compliance pathway (e.g., predetermined or applied for) and/or the biofuel meeting a predetermined GHG emission threshold. For example, with regard to the former, the RFS2 categorizes biofuel as cellulosic biofuel, advanced biofuel, renewable biofuel, and biomass-based diesel. With regard to the latter, to be a renewable biofuel under the RFS2, corn ethanol should have lifecycle GHG emissions at least 20% lower than an energy-equivalent quantity of gasoline (e.g., 20% lower than the 2005 EPA average gasoline baseline of 93.08 gCO₂eq/MJ). In low carbon-related fuel standards, biofuels may be credited according to the carbon reductions of their pathway. For example, under California's LCFS, each biofuel is given a carbon intensity score indicating their GHG emissions as grams of CO₂ equivalent per megajoule (MJ) of fuel, and credits are generated based on a comparison of their emissions reductions to a target or standard that may decrease each year (e.g., in 2019, ethanol was compared to the gasoline average carbon intensity of 93.23 gCO₂eq/MJ), where lower carbon intensities generate proportionally more credits.

In certain embodiments of the disclosure, the process includes monitoring inputs and/or outputs from each of the biomethane production, hydrogen production, and/or CCS. In this case, each of the inputs is a material input or energy input and each of the outputs is a material output or an energy output. Monitoring inputs and/or outputs of these process may facilitate calculating and/or verifying GHG emissions of the process, calculating and/or verifying carbon intensity of the fuel, fuel intermediate, or chemical product, may facilitate credit generation (e.g., based on volumes of fuel produced), and/or may facilitate determining renewable content (e.g., when co-processing renewable and non-renewable fuels). Monitoring can be conducted over any time period (e.g., monthly statements, etc.). Monitoring can be conducted in conjunction with and/or using any suitable technology or combination of technologies that enables measurement of material and/or energy flows.

Meeting a Target CI and/or Clean Hydrogen Standards

In certain embodiments of the disclosure, the process includes producing hydrogen that is treated as clean hydrogen under applicable regulations (e.g., produced in compliance with a greenhouse gas emissions standard established by government). In general, clean hydrogen, which is produced with relatively low GHG emissions (e.g., low relative to GHG emissions associated with the steam methane reforming of non-renewable natural gas), may be produced using low-carbon power (e.g., via electrolysis using renewable power), from fossil fuels (e.g., via the steam methane reforming of non-renewable natural gas where carbon dioxide generated during hydrogen production is provided for CCS), and/or from renewable feedstocks (e.g., via the steam methane reforming of biomethane feedstock). Whether such hydrogen and/or its production qualifies as clean hydrogen under applicable regulations and/or qualifies for one or more credits can depend on the applicable regulations (e.g., on the clean hydrogen standards). In one approach to determining whether hydrogen qualifies as clean hydrogen, the GHG emissions of hydrogen production are compared to some lifecycle GHG emission threshold as a percent savings relative to a fossil comparator. For example, in one approach clean hydrogen could require an at least 60% GHG savings versus a natural gas SMR benchmark of 91 gCO₂eq/MJ (LHV). In general, the CI of such fossil comparators can depend on the applicable regulations. For purposes herein, a “fossil comparator” for hydrogen production has a CI of about 102 gCO₂eq/MJ H₂ (LHV), unless stated otherwise.

In certain embodiments, the process includes producing hydrogen that meets a target CI that achieves an at least about 80%, at least about 85%, at least about 90%, at least about 92%, or at least about 95% reduction in lifecycle GHG emissions as compared to the fossil comparator having a CI of about 102 gCO₂eq/MJ H₂ (LHV). For example, in one embodiment, the process includes producing hydrogen that has a CI that is about 10 gCO₂eq/MJ H₂ (LHV) or lower (e.g., equal to 10.2 gCO₂eq/MJ (LHV) or lower), and thus achieves a GHG emissions reduction of at least about 90% relative to the fossil comparator. In one embodiment, the process includes producing hydrogen having a CI of about 5 gCO₂eq/MJ H₂ (LHV) or lower (e.g., equal to 5.1 gCO₂eq/MJ (LHV) or lower), and thus achieves a GHG emissions reduction of at least about 95% relative to the fossil comparator. In certain embodiments, the process includes producing hydrogen that meets a target CI that is at about 7 gCO₂eq/MJ H₂ (LHV) or lower, about 8 gCO₂eq/MJ H₂ (LHV) or lower, or about 9 gCO₂eq/MJ H₂ (LHV) or lower.

While some green hydrogen facilities that produce hydrogen via electrolysis using renewable power may meet such thresholds (e.g., about 90% or about 95% emissions reduction relative to the fossil comparator), it can be more challenging for conventional and/or blue hydrogen facilities, the latter of which generally produce hydrogen from fossil fuels in a process that is integrated with CCS, to meet such thresholds. For example, while it is theoretically possible to capture most of the carbon dioxide produced from hydrogen production based on the reforming of natural gas, in practice, the resulting so called blue hydrogen is often associated with significant GHG emissions. Without being limiting, some emissions from blue hydrogen production may be related to the use of natural gas (e.g., pipeline losses), while other emissions may result from the hydrogen production and/or capture process. With regard to the capture process, emissions from CCS may be related to electricity used within the process (e.g., for compression) and/or to natural gas used within the process (e.g., for generating steam for an amine regenerator). With regard to hydrogen production, hydrogen produced from SMR typically generates carbon dioxide both from the feedstock fed to methane reforming and from the feedstock used to generate heat for the reforming. Carbon dioxide generated from the feedstock used to generate heat for the reforming can be captured from the flue gas (e.g., emitted from the SMR furnace). Carbon dioxide generated from the feedstock fed to methane reforming (e.g., generated from the reforming reactions, including the WGS reactions, if present) can be obtained from 1) the syngas (e.g., downstream of WGS, and upstream of or as part of hydrogen purification), 2) off-gas produced from hydrogen purification (e.g., from PSA purge gas), and/or 3) from the flue gas when off-gas from hydrogen purification is recycled to generate heat for the reforming (e.g., recycled to SMR burners).

It has been found that providing biomethane feedstock to replace a portion of the non-renewable gaseous feedstock used for methane reforming (e.g., in conventional hydrogen production or blue hydrogen production) can achieve a lifecycle GHG emissions reduction of at least about 90% or at least about 95% (i.e., versus the fossil comparator). For example, when a portion of the non-renewable gaseous feedstock is replaced with biomethane feedstock, the hydrogen is produced using aggregate feedstock. For purposes herein, the term “aggregate feedstock” refers to feedstock that includes multiple components (e.g., biomethane feedstock and non-renewable gaseous feedstock). Hydrogen produced from an aggregate feedstock containing both the non-renewable gaseous feedstock and the biomethane feedstock has a carbon intensity that is dependent, at least in part, on the carbon intensity of both the non-renewable gaseous feedstock and the biomethane feedstock (e.g., can be determined using an aggregate carbon intensity based on both the non-renewable gaseous feedstock and the biomethane feedstock). Such aggregate carbon intensities are typically weighted-average carbon intensities. Accordingly, replacing a portion of the non-renewable gaseous feedstock with biomethane feedstock can facilitate the production of clean hydrogen, at least in part, from fossil fuels (e.g., natural gas).

It has additionally been found that, when combined with a process that includes capturing and sequestering carbon dioxide from hydrogen production, providing biomethane feedstock to replace a portion of the non-renewable gaseous feedstock used for methane reforming can produce a substantially disproportional reduction in lifecycle GHG emissions for the hydrogen produced. Consider the following example where carbon dioxide is captured and sequestered from a blue hydrogen production process based on the SMR of non-renewable gaseous feedstock.

In this example, the capture efficiency for the blue hydrogen production is 90%, and the hydrogen produced has a carbon intensity of about 28.5 gCO₂eq/MJ (LHV) (e.g., about 3.45 kgCO₂eq emitted per kg H₂ produced). If 14.1% of the non-renewable gaseous feedstock having a carbon intensity of about 72 gCO₂eq/MJ (LHV) is replaced with biomethane having a carbon intensity of −72 gCO₂eq/MJ (LHV), then the hydrogen produced has a carbon intensity of about of about 3.6 gCO₂eq/MJ (LHV) (e.g., about 0.44 kgCO₂eq emitted per kg H₂ produced), which corresponds to an emissions reduction of about 87% (i.e., relative to without the replacement). In contrast, if 14.1% of the non-renewable gaseous feedstock having a carbon intensity of about 72 gCO₂eq/MJ (LHV) is replaced with biomethane having a carbon intensity of −72 gCO₂eq/MJ (LHV), where there is no carbon dioxide captured and sequestered from hydrogen production (e.g., conventional hydrogen production), the emissions reduction achieved is only about 23% (i.e., relative to without the replacement of non-renewable gaseous feedstock). In certain embodiments, a sufficient amount of carbon dioxide is captured from hydrogen production to ensure that replacing a portion of the non-renewable gaseous feedstock with biomethane feedstock results in a lifecycle GHG emissions reduction of at least about 50%, at least about 60%, at least about 70%, at least about 80%, or at least about 90% (i.e., relative to without the replacement). In certain embodiments, the carbon dioxide capture rate from hydrogen production is at least at least about 70%, at least about 80%, at least about 85%, at about 90%, or at least about 95%. In certain embodiments, a sufficient amount of carbon dioxide is captured from hydrogen production to ensure that replacing a portion of the non-renewable gaseous feedstock with biomethane feedstock results in a lifecycle GHG emissions reduction of at least about 50%, at least about 60%, at least about 70%, at least about 80%, or at least about 90% (i.e., relative to without the replacement), and the carbon dioxide capture rate from hydrogen production is at least at least about 70%, at least about 80%, at least about 85%, at about 90%, or at least about 95%.

It has been also found that providing biomethane feedstock to replace a portion of the non-renewable gaseous feedstock used for methane reforming, when combined with CCS, can achieve a GHG emissions reduction of at least 90% or at least 95% (i.e., versus the fossil comparator) even when less than 50% of the non-renewable feedstock is replaced with biomethane feedstock. This is particularly advantageous because biomethane feedstock is generally considered a scarce and/or expensive resource (i.e., relative to natural gas), especially when it has a carbon intensity that is less than 25 gCO₂eq/MJ, and in particular, less than 15 gCO₂eq/MJ. As a result of its relative scarcity and/or higher cost, it can be advantageous to minimize the amount of biomethane feedstock used to replace the non-renewable gaseous feedstock while still meeting a target carbon intensity (e.g., corresponding to a 95% emissions reduction relative to the fossil comparator). In certain embodiments, the fraction r of biomethane feedstock that replaces the non-renewable gaseous feedstock is limited to less than about 80%, less than about 70%, less than about 60%, less than about 50%, less than about 40%, less than about 30%, or less than about 25%. Using feedstock that contains both the non-renewable gaseous feedstock and the biomethane feedstock, where the biomethane feedstock makes up less than 60% of the total feedstock, and particularly less than 50% of the total feedstock, can allow the hydrogen production to benefit from the lower cost and greater availability of fossil-based natural gas, while still providing hydrogen having relatively low carbon intensity.

In addition, it has been found that providing biomethane feedstock to replace a portion of the non-renewable gaseous feedstock used for methane reforming, when combined with CCS from one or more selected points in the process can be particularly advantageous. For example, it can be advantageous to provide carbon dioxide for sequestration, when the carbon dioxide is captured from streams that have a relatively high pressure and/or relatively high carbon dioxide content (i.e., mole fraction). Using streams having a relatively high carbon dioxide content can reduce separation costs and/or produce more carbon dioxide (by mass) for a given separation process. Using streams having relatively high pressures can reduce equipment size and/or reduce compression costs (e.g., carbon dioxide removal technologies often operate with greater efficiency at elevated pressures and/or can produce carbon dioxide streams at a relatively high pressure, thereby reducing the compression costs to inject carbon dioxide into a carbon dioxide distribution system, such as a pipeline).

Without being limiting in any way, flue gas may have a carbon dioxide content of up to about 20% (on a wet basis, or up to 25% on a dry basis), with the remainder being largely nitrogen and some oxygen, and is often at about atmospheric pressure (e.g., about 0.1 MPA); syngas may have a carbon dioxide content between about 16 and 20% (on a dry basis), with the remainder being largely hydrogen, in addition to some methane and carbon monoxide, and can be at about 3 MPa; off gas from PSA may have a carbon dioxide content of about 50% (on a dry basis), with the remainder being largely carbon monoxide, hydrogen, and methane, and can be at about 0.2 MPa. Without being limiting in any way, raw biogas can have carbon dioxide content of about 40% (on a dry basis) and is often collected at pressures of about 0.2 MPa. As will be understood by those skilled in the art, the carbon dioxide content of each of these streams can be dependent on the process. For example, the carbon dioxide content of raw biogas can be dependent on the feedstock and/or anaerobic digestion process. The carbon dioxide content of flue gas can be dependent on whether off-gas from hydrogen purification and/or a portion of the hydrogen product is combusted in the SMR furnace.

In certain embodiments, the use of biomethane feedstock is combined with the use of CCS, where carbon dioxide is captured from one or more streams having a relatively high carbon dioxide content and/or pressure. In certain embodiments, the use of biomethane feedstock is combined with the use of CCS, where carbon dioxide is captured from one or more selected points in the process. In certain embodiments, the one or more selected points are chosen such that carbon dioxide is captured from:
a) biomethane production (e.g., captured as part of biogas upgrading, or from a stream produced during biogas upgrading),
b) an off-gas, such as purge gas, produced from hydrogen purification,
c) syngas produced from methane reforming (e.g., from water gas shift), and/or
d) flue gas (e.g., from the SMR furnace).

In certain embodiments, the one or more selected points are chosen from the above list, according to the order of the list. For example, in certain embodiments, the use of biomethane feedstock is combined with the use of CCS, where carbon dioxide is captured from biomethane production. In certain embodiments, the use of biomethane feedstock is combined with the use of CCS, where carbon dioxide is captured from biomethane production and from an off-gas, such as purge gas, produced from hydrogen production. Providing CCS of carbon dioxide captured from an off-gas, and in particular from a purge gas from PSA, can be advantageous in that purge gas may be at an elevated pressure and because the carbon dioxide content can be higher than from syngas, which generally has a relatively high hydrogen content. Selecting streams that have relatively high carbon dioxide content and/or are at a relatively high pressure (e.g., relative to flue gas) may reduce the cost of capturing a certain quantity of carbon dioxide, while facilitating capturing a quantity of carbon dioxide that can help meet a GHG emission reduction of 95% and while reducing the amount of biomethane feedstock required (e.g., r under 50%).

In certain embodiments, carbon dioxide is captured and provided for sequestration from one or more streams, where each stream has a carbon dioxide content greater than about 20%, greater than about 25%, greater than about 30%, greater than about 35%, or greater than about 40%, each on a dry basis, and a pressure that is greater than about atmospheric (e.g., greater than about 0.1 MPa). In certain embodiments, carbon dioxide is captured and provided for sequestration from one or more streams, where each stream has a carbon dioxide content greater than about 20%, greater than about 25%, greater than about 30%, greater than about 35%, or greater than about 40%, each on a dry basis, and a pressure that is greater than about 0.2 MPa, greater than about 0.3 MPa, greater than about 0.4 MPa, greater than about 0.5 MPa, greater than about 1 MPa, or greater than about 2 MPa. Selecting gas streams that have a carbon dioxide content greater than about 20% on a dry basis, and in particular greater than 25% on a dry basis, can be advantageous because for a given cost and/or GHG emissions associated with carbon capture of a certain mass of gas, more carbon dioxide can be removed.

In certain embodiments, carbon dioxide is captured and provided for sequestration from one or more streams, where each stream has a carbon oxide content (i.e., sum of the carbon dioxide content and the carbon monoxide content) greater than about 20%, greater than about 25%, greater than about 30%, greater than about 30%, greater than about 35%, greater than about 40%, greater than about 45%, or greater than about 50%, each on a dry basis, and a pressure that is greater than about atmospheric.

In certain embodiments, carbon dioxide is captured and provided for sequestration only from streams having a nitrogen content of about 10% or lower, about 8% or lower, about 6% or lower, about 4% or lower, or about 2% of lower. In certain embodiments, carbon dioxide is captured and provided for sequestration from hydrogen production only from streams having a nitrogen content of about 10% or lower, about 8% or lower, about 6% or lower, about 4% or lower, or about 2% of lower.

In certain embodiments, carbon dioxide generated from feedstock fed to methane reforming is captured (e.g., from the syngas and/or off gas from hydrogen purification) and provided for sequestration. In certain embodiments, carbon dioxide generated from feedstock used to generate heat for the reforming is alternatively or additionally captured (e.g., from the flue gas) and provided for sequestration. It has been found that it can be advantageous to capture no more than 40% of the total carbon dioxide generated during hydrogen production from flue gas from SMR based hydrogen production. Without being limiting in any way, and depending on the specific process, typically about 40% of the carbon dioxide generated from SMR based hydrogen production may be generated in the reformer furnace (e.g., and thus can be captured from the flue gas), while about 60% is generated from feedstock fed to methane reforming (e.g., and thus can be captured from the syngas or a stream derived from the syngas, such as off-gas from hydrogen purification). When off-gas from hydrogen purification (e.g., purge gas) contains carbon dioxide generated from feedstock fed to methane reforming and is recycled to produce heat for the reforming, then the flue gas can contain almost all of the carbon dioxide generated during hydrogen production (e.g., the carbon dioxide generated from both the feedstock fed to reforming and the feedstock used to generate heat for the reforming). While it may seem beneficial to provide only one point in the hydrogen production process from which carbon dioxide is captured (e.g., from the flue gas), in certain embodiments, carbon capture for sequestration is provided at multiple points, and no more than 40% of the total carbon dioxide generated during hydrogen production is captured from the flue gas. For example, in certain embodiments, if carbon dioxide is captured from the flue gas, it is also captured from the syngas and/or an off gas from hydrogen purification (e.g., using absorption). In certain embodiments, no carbon dioxide is captured from the flue gas.

In certain embodiments, the hydrogen production facility is based on SMR and is configured for carbon capture and sequestration, and more specifically is configured to capture more than 90% of the carbon dioxide generated from hydrogen production. In such embodiments, the carbon dioxide can be captured only from flue gas (i.e., post combustion) or can be captured from both from (i) flue gas and (ii) syngas and/or off-gas from hydrogen purification (e.g., precombustion). In such embodiments, replacing less than 50% of the non-renewable feedstock with biomethane feedstock can facilitate meeting a target CI corresponding to a 95% GHG emissions reduction relative to a fossil comparator, without having to provide CCS of carbon dioxide generated from the biomethane production and/or when the biomethane feedstock has a relatively high CI (e.g., is landfill gas). Such embodiments are particularly advantageous for facilitating obtaining one or more credits from blue hydrogen production that otherwise would not meet a target CI. In other embodiments, the target CI is some desired CI (e.g., having a value below zero).

In certain embodiments, the hydrogen production facility is based on ATR and is configured for carbon capture and sequestration, and more specifically is configured to capture more than 90% of the carbon dioxide generated from hydrogen production (e.g., from the syngas and/or from off-gas from hydrogen purification). In such embodiments, replacing less than 50% of the non-renewable feedstock with biomethane feedstock may facilitate meeting a target CI corresponding to a 95% GHG emissions reduction relative to a fossil comparator, without having to provide CCS of carbon dioxide generated from the biomethane production and/or when the biomethane feedstock has a relatively high CI (e.g., is landfill gas). Such embodiments are particularly advantageous for facilitating obtaining one or more credits from ATR based hydrogen production combined with CCS that otherwise would not meet a target CI.

In certain embodiments, the hydrogen production facility (e.g., based on SMR and/or ATR reforming technologies) is configured for carbon capture and sequestration, and more specifically is configured to capture carbon dioxide from syngas and/or from off-gas from hydrogen purification, but not from flue gas (i.e., if present). Advantageously, such embodiments allow a large portion of the carbon dioxide generated from hydrogen production to be captured, without having to capture carbon dioxide from flue gas. For example, since carbon dioxide in the syngas/off-gas is typically less challenging to capture than carbon dioxide in flue gas (e.g., economically), which is generally at a lower pressure and/or concentration and/or may have a significant nitrogen content, the cost can be expected to be relatively low. In such embodiments, a 95% emission reduction can still be achieved by using biomethane feedstock having a relatively low CI. For example, it can be advantageous to use biomethane feedstock derived from animal waste and/or food waste, and thus associated with avoided emissions of methane to the atmosphere. Alternatively, or additionally, the low CI can be achieved as a result of carbon dioxide obtained from the biogas being provided for sequestration. It has been found that the combination of sequestering carbon dioxide generated from methane reforming reactions (e.g., captured from the syngas and/or off-gas from hydrogen production) with sequestration of carbon dioxide from biomethane production, can facilitate meeting a target CI corresponding to a 95% GHG emissions reduction relative to the fossil comparator, while still replacing less than 50% of the non-renewable feedstock with biomethane feedstock and while not capturing carbon dioxide from flue gas (if present). Such embodiments are particularly advantageous for facilitating obtaining one or more credits from blue hydrogen production based on SMR that does not capture carbon dioxide from flue gas and that otherwise would not meet a target CI. For example, such embodiments can facilitate hydrogen producers that only use precombustion capture, or want to install only precombustion capture, to produce hydrogen that meets a target CI (e.g., associated with clean hydrogen) without having to install a post combustion capture system at the hydrogen production facility. Such embodiments may also incentivise biomethane producers to capture carbon dioxide for sequestration.

In certain embodiments, a hydrogen production facility produces hydrogen by reforming non-renewable gaseous feedstock (e.g., based on SMR and/or ATR), thereby generating syngas that includes at least hydrogen, carbon monoxide, and carbon dioxide. When the reforming is based on SMR, non-renewable gaseous feedstock is also combusted to produce heat for the reforming reactions, thereby producing flue gas containing at least carbon dioxide. At least some of the carbon dioxide (e.g., from the syngas and/or flue gas) is captured and provided for sequestration (e.g., injected into a carbon dioxide pipeline). Depending on the applicable regulations, injecting the captured carbon dioxide into a carbon dioxide pipeline may reduce the lifecycle GHG emissions associated with the hydrogen production on the basis of displacement (e.g., preventing an equivalent amount of carbon dioxide from being withdrawn from a naturally occurring underground carbon dioxide deposit). Carbon dioxide captured from the syngas may be captured as part of hydrogen purification (e.g., one or more processes used to separate hydrogen from other components such as carbon dioxide). For example, the syngas can be subjected to hydrogen purification that includes a first separation that separates the carbon dioxide from other components of the syngas followed by a second separation that separates the hydrogen from the remaining components of the syngas. In such embodiments, the hydrogen produced from the hydrogen facility using only non-renewable gaseous feedstock does not meet a target CI (e.g., corresponding to a 90% or 95% GHG emissions reduction relative to the fossil comparator). In order to reduce the CI of the hydrogen, a fraction of the non-renewable gaseous feedstock is replaced with biomethane feedstock, where the biomethane feedstock is produced in process that includes capturing carbon from biogas and providing the captured carbon dioxide for sequestration.

In certain embodiments, the use of biomethane feedstock is combined with the use of CCS, where carbon is captured from at least two points outside of hydrogen production. In certain embodiments, the use of biomethane feedstock is combined with the use of CCS, where carbon dioxide is captured from at least two points other than hydrogen production. For example, carbon dioxide generated during anaerobic digestion and carbon-containing material derived from digestate can be part of one or more carbon capture and sequestration process.

In the above-described embodiments, the non-renewable gaseous feedstock that is replaced can be (a) feedstock fed to methane reforming and/or (b) feedstock used to generate heat for the reforming reactions. In certain embodiments, the biomethane feedstock provided to produce a batch of hydrogen is substantially all fed to methane reforming (i.e., is feedstock for the reforming reaction(s)). In certain embodiments, at least some of the biomethane feedstock provided to produce a batch of hydrogen is fed to methane reforming. In certain embodiments, the biomethane feedstock provided to produce a batch of hydrogen is substantially all fed used to generate heat for the reforming reactions. In certain embodiments, at least some of the biomethane feedstock provided to produce a batch of hydrogen is used to generate heat for the reforming reactions. In certain embodiments, the biomethane feedstock provided to produce a batch of hydrogen is predominately fed to methane reforming such that the feedstock subjected to methane reforming has a higher biomethane fraction than the feedstock combusted for generating heat for the reforming. In certain embodiments, the biomethane feedstock provided to produce a batch of hydrogen is predominately provided for combustion to generate heat for the reforming such that the feedstock subjected to methane reforming has a lower biomethane fraction than the feedstock combusted for generating heat for the reforming.

In the above-described embodiments, the fraction of non-renewable gaseous feedstock to be replaced with biomethane feedstock can be selected to just meet the target carbon intensity (CI_{T}), thereby minimizing the amount of biomethane feedstock used (e.g., by energy). It is particularly advantageous that hydrogen production that meets a very high GHG emission reductions (e.g., greater than 90%, or even greater than 95%) relative to a fossil comparator having a CI of 102 gCO₂eq/MJ H₂ (LHV) can be produced from feedstock containing non-renewable gaseous feedstock, when less than half of the non-renewable feedstock is replaced with biomethane feedstock (e.g., achieving close to maximum emission reductions with a minimal amount of biomethane).

### EXAMPLES

### Example 1: Meeting a Target CI in an Oil Refinery

The following example demonstrates how hydrogen can be produced in a hydrogen production facility within an oil refinery that meets a target carbon intensity (CI_{T}). Advantageously, the target CI can correspond to a GHG reduction that is as high as a 95% relative to a baseline as defined herein. The method comprises replacing, at the hydrogen production facility, a fraction of the non-renewable gaseous feedstock, in this example natural gas, with a biomethane feedstock having a low CI value, such as between 15 gCO₂eq/MJ and −500 gCO₂eq/MJ. The non-renewable gaseous feedstock replaced is either feedstock fed to methane reforming and/or feedstock used to generate heat for the reforming in the hydrogen production.

The fraction of the natural gas feedstock to be replaced is represented by r and is determined by Equation A set forth below. The calculated r value enables a hydrogen producer to easily select a defined fraction of natural gas to be replaced with the biomethane feedstock to achieve a target CI or a target GHG emissions reduction set by legislators. This in turn enables a hydrogen producer or other entity to obtain valuable credits and thereby incentivizes hydrogen production having a low target CI value.

The fraction r takes into consideration the CI of the biomethane feedstock. In this non-limiting example, in order to ensure that the amount of natural gas replaced at the hydrogen production facility is less than 50%, the CI of the biomethane feedstock is between 15 gCO₂eq/MJ and −500 gCO₂eq/MJ (determined using GREET).

By ensuring the CI of the biomethane feedstock falls within this low CI range, less than half of the natural gas used in reforming, and/or that replaces the heat to fuel the reforming, is most desirably replaced with the biomethane. This saves cost as the oil refinery can continue to use feedstock obtained from established sources using existing infrastructure (e.g., natural gas from a pipeline), yet allows the greenhouse gas emissions of the hydrogen to be reduced to below a desired threshold value (e.g., meet the target CI). Advantageously, the target CI can be reached with the minimal amount of biomethane feedstock, which can be a relatively scarce resource (e.g., compared to fossil-based natural gas). The process may also act as a bridge between the use of conventional fossil fuels to greener alternatives, thereby easing the transition to greener alternatives in the future. In general, this approach can provide a cost-effective approach for reducing carbon intensity.

In this example, the target carbon intensity (CI_{T}) corresponds to a 95% GHG emissions reduction measured relative to a fossil baseline set by regulators as this achieves the greatest benefits to a hydrogen producer under proposed U.S. legislation in the form of credits. However, other target values can be achieved by replacing a defined quantity of natural gas with the low CI biomethane as defined by r.

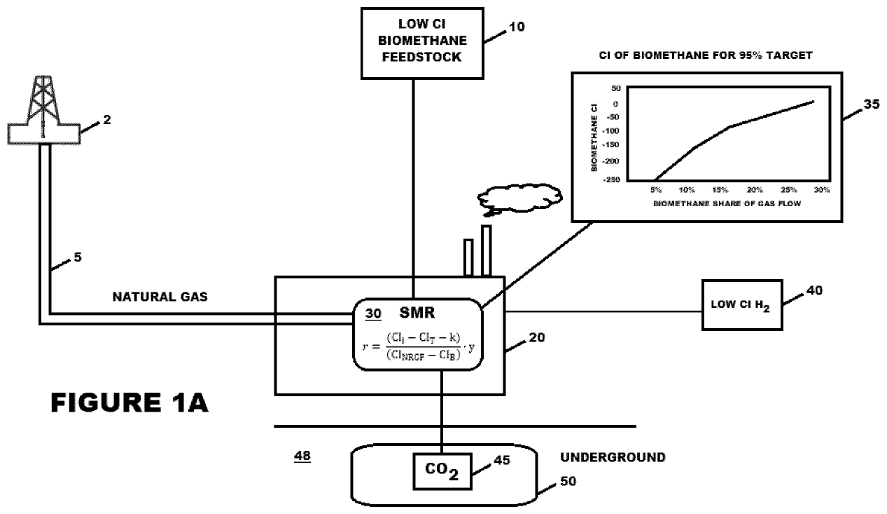

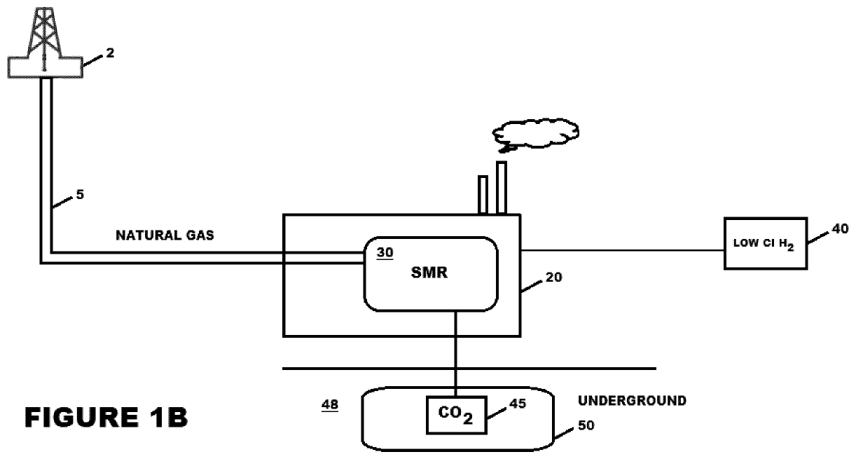

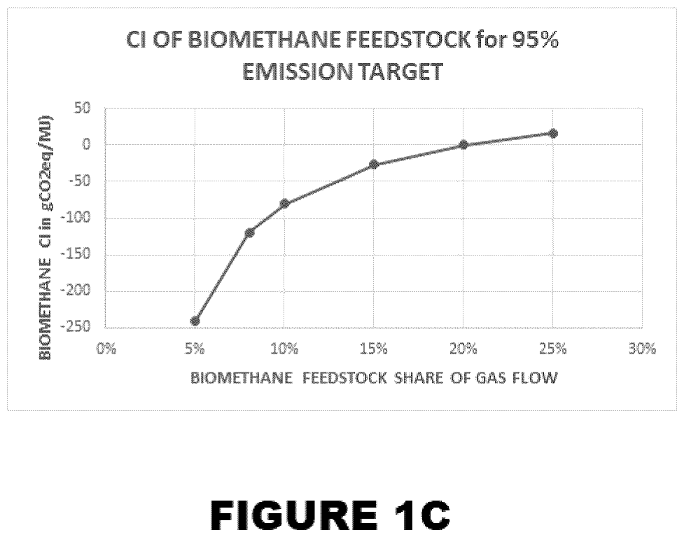

With reference to FIG. 1A, an oil refinery 20 is shown that comprises a steam methane reforming unit, shown as SMR 30 that is located within a hydrogen production facility of the oil refinery 20. In this non-limiting example, the non-renewable gaseous feedstock fed to the SMR 30 is natural gas extracted from the earth from fossil sources by a well 2. The natural gas 5 after conventional processing is introduced to a pipeline and withdrawn at the oil refinery 20 and fed to the SMR 30 to produce hydrogen. In turn, the hydrogen is used in hydroprocessing operations to upgrade crude oil in the oil refinery 20.

A low CI biomethane feedstock 10 is sourced having a carbon intensity (CI) value within a range that is between 15 gCO₂eq/MJ and −500 gCO₂eq/MJ. The low CI biomethane feedstock 10 may be obtained from an anaerobic digestion of an organic material, such as animal waste, followed by collection of methane and carbon dioxide and sequestration of the carbon dioxide underground. Further examples to obtain the low CI biomethane are described below.

At the oil refinery 20, a fraction r of the natural gas 5, shown by the equation, is replaced with the low CI biomethane feedstock 10 in the SMR 30. As mentioned, the fraction r of natural gas 5 replaced is less than 50%. By selecting an appropriate r, a low CI hydrogen 40 is produced that meets the target hydrogen CI. The determination of r using the equation is described in more detail in Example 2.

The graph 35 (shown to the right of the drawing) is a simplified drawing that depicts the CI of the low CI biomethane vs. the biomethane share of gas flow. Without being limiting, such graph 35 may be generated to determine the fraction of the low CI biomethane feedstock 10 that replaces the natural gas 5 as a function of its CI value to achieve a given target carbon intensity (CI_{T}) of the hydrogen. The graph 35 is shown for illustration only and is simplified in order to facilitate an understanding of certain advantageous features of the invention. FIG. 1C shows a similar graph generated using Equation A.

In this non-limiting example, the target CI_{T} associated with the hydrogen corresponds to a 95% GHG reduction relative to a baseline set by regulators. As can be seen, the graph 35 depicts that the lower the CI of the biomethane feedstock 10, the lower the share of the biomethane feedstock 10 used to make up the gas flow of SMR 30 to achieve a target hydrogen (CI_{T}). The biomethane feedstock 10 share of gas flow to achieve a target carbon intensity (CI_{T}) of the hydrogen as shown in the graph 35 may depend on the initial carbon intensity (CIᵢ) of the hydrogen produced at the oil refinery 20 using solely natural gas 5 as the feedstock to SMR 30. Optionally, carbon dioxide 45 produced as a byproduct during steam methane reforming 30 is sequestered underground 48 in a reservoir 50 to reduce GHG emissions. This reduces the carbon intensity of the hydrogen produced at the oil refinery 20 relative to CIᵢ, which in turn reduces the biomethane share of gas flow in SMR 30 used to achieve the target carbon intensity (CI_{T}) of the hydrogen. The equation to calculate r factors in this reference initial carbon intensity (CIᵢ) of the hydrogen, as discussed below, to arrive at an r value to achieve the target carbon intensity (CI_{T}) of the hydrogen.

### Example 2: Determining the Fraction r of Biomethane Feedstock that Replaces Natural Gas

As discussed in Example 1, the fraction r of low CI biomethane feedstock 10 that replaces the natural gas 5 in FIG. 1A is determined by the following equation:

$$r = \frac{( {CI}_{i} - {CI}_{T} - k - {C}_{r} )}{( {CI}_{NRGF} - {CI}_{B} )} \cdot y , \qquad Equation A$$

wherein the CI values of Equation A are expressed in gCO₂eq/MJ.

Each of the variables of Equation A is described in more detail below with reference to the non-limiting example set forth in Example 1 above and depicted in FIG. 1A. The description below of each parameter of Equation A should not be construed as limiting to the invention in any way and is merely provided to illustrate certain advantageous embodiments of the invention. For example, Equation A is described with reference to an oil refinery but is equally applicable to a hydrogen production facility located in a fertilizer plant or a stand-alone hydrogen production facility.

The CIᵢ is a calculated carbon intensity of the hydrogen 40 produced by the SMR 30 produced using only natural gas 5 (i.e., without replacement of the low CI biomethane feedstock 10). Such a process is depicted in FIG. 1B in which only natural gas 5 is used in SMR 30. (FIG. 1B is otherwise identical to FIG. 1A, in which like references number depict the same or similar streams or unit operations between the two figures). The CIᵢ value does not account for any reductions in CI due to the carbon capture and sequestration, such as the introduction of CO₂ 45 (produced as a byproduct in SMR 30) in a reservoir 50 located underground 48 as depicted in FIG. 1B.

The CI_{T} is the target carbon intensity of the low CI H₂ 40 to be produced in the hydrogen production facility. In FIG. 1A, the low CI H₂ 40 achieves a carbon intensity corresponding to a 95% emissions reduction relative to a baseline set by regulators as shown in graph 35.

The k of Equation A is the net amount of carbon dioxide 45 captured and sequestered per unit of hydrogen produced in gCO₂eq/MJ. As noted above, the carbon dioxide 45 is a byproduct of SMR 30 and can be introduced underground 48 in a reservoir 50. It will be noted that k is zero when no carbon dioxide 45 is captured and introduced underground 48 in a reservoir 50. In other words, Equation A factors in any emission reductions from carbon capture and sequestration of carbon dioxide produced during hydrogen production that are already implemented in an oil refinery 20 prior to the replacement of natural gas 5 with the low CI biomethane feedstock 10, such as depicted in FIG. 1B. (However, as would be appreciated by those of skill in the art, such sequestration could also be implemented after the replacement or during such replacement). The Cᵣ of Equation A is the carbon dioxide emissions reduction per unit of hydrogen produced in gCO₂eq/MJ attributable to using renewable power in or associated with hydrogen production.

The CI_{NRGF} is the carbon intensity of the non-renewable gaseous feedstock (NRGF) fed to the hydrogen production facility. In FIG. 1A, the non-renewable gaseous feedstock is the natural gas 5 fed to the SMR 5.

The CI_{B} is the carbon intensity of biomethane feedstock 10 fed to the hydrogen production facility. In FIG. 1A, the hydrogen production facility is located within the oil refinery 20.

The y of Equation A is a ratio of energy of the hydrogen produced in MJ to the sum of energy of the non-renewable gaseous feedstock in MJ and the biomethane feedstock provided in MJ, for a given time period (e.g., a type of energy yield). In FIG. 1A, this is the ratio of the energy of the hydrogen 40 produced to the sum of energy of the natural gas feedstock 5 and the biomethane feedstock 10.

FIG. 1C is a graph showing CI_{B} in gCO₂eq/MJ vs. the biomethane feedstock share of gas flow to achieve a CI_{T} corresponding to a 95% emissions reduction relative to a baseline (e.g., set by a regulatory agency). In this example, it is assumed that k is 60 gCO₂eq/MJ. It will be understood that the carbon intensity (CI) for each variable of Equation A is determined using a method selected according to prevailing rules and regulations in an applicable jurisdiction relevant to desired credits and can be readily calculated by those of ordinary skill in the art using techniques established by relevant regulatory bodies.

### Example 3: Producing a Low CI Biomethane Feedstock

As noted previously, in certain embodiments, the low CI biomethane feedstock provided to the hydrogen production facility is prepared so that it has a CI value within a range that is between 15 gCO₂eq/MJ and −500 gCO₂eq/MJ. The CI value is obtained by at least one of:
(a) capturing and sequestering carbon dioxide generated from an anaerobic digestion or gasification that formed the biomethane feedstock;
(b) capturing and sequestering carbon from a residue of the anaerobic digestion or gasification that formed the biomethane feedstock;
(c) using a renewable energy source to power a production process for producing the biomethane feedstock; and/or
(d) processing animal waste and avoiding emissions of methane to atmosphere that would otherwise have been released without production and collection of the biomethane feedstock.

Non-limiting examples of steps (a)-(d) above are illustrated in FIG. 2A-2D, respectively, below. In FIGS. 2A-2D, like reference numbers depict the same or similar unit operations or process streams.

With reference to FIG. 2A, biomass is sent to anaerobic digestion 1 in which the biomass is digested to produce biogas that is a gas mixture comprising methane (CH₄) and carbon dioxide (CO₂), and that typically additionally comprises water (H₂O), nitrogen (N₂), hydrogen sulfide (H₂S), ammonia (NH₃), oxygen (O₂), volatile organic compounds (VOCs), and/or siloxanes, depending on the biomass from which it is produced. The biogas is upgraded in biogas upgrading 3 to remove the carbon dioxide (CO₂) 45A and the additional unwanted components. The carbon dioxide 45A is introduced underground 48A in a reservoir 50A (after optional processing that includes purification). The resultant low CI biomethane feedstock 10 having a CI that is between 15 gCO₂eq/MJ and −500 gCO₂eq/MJ is sent to the SMR 30 in an oil refinery 20 as described previously with reference to FIG. 1A. As discussed, the SMR 30 can be part of a hydrogen production facility in an ammonia and/or fertilizer plant or a stand-alone facility to produce hydrogen for direct use as a fuel or as industrial feedstock (e.g., to upgrade other fuels).

FIG. 2B likewise depicts biomass that is sent to anaerobic digestion 1 in which it is digested to produce biogas comprising methane (CH₄) and carbon dioxide (CO₂), among other components, such as those described previously, and a digestate 5. Digestate 5 can include organic material not digested by the anaerobic microorganisms, byproducts of the anaerobic digestion released by the microorganisms, and/or the microorganisms themselves. For example, the digestate 5 can include carbohydrates, nutrients (such as nitrogen compounds and phosphates), other organics, and/or wild yeasts. At least part of the digestate 5 may be used as a fertilizer 52 (e.g., soil conditioner), where it can provide nutrients for plant growth and/or displace the use of fossil-based fertilizers. However, digestate 5 used as a fertilizer 52 may have a significant methane formation potential, and thus may be associated with GHG emissions. In certain embodiments of the disclosure, the digestate 5 is processed in digestate processing 50B to provide carbon-containing material 45B that that can be sequestered underground 48B in a reservoir 50B.

The biogas is upgraded in biogas upgrading 3 to remove the carbon dioxide (CO₂) 45A and the additional components. The low CI biomethane feedstock that is designated as having a CI between 15 gCO₂eq/MJ and −500 gCO₂eq/MJ (determined by the GREET Model) is sent to the SMR 30 in an oil refinery 20 as described previously with reference to FIG. 1A.

With reference to FIG. 2C, biomass is sent to anaerobic digestion 1 in which the biomass 1 is digested to produce biogas comprising methane (CH₄) and carbon dioxide (CO₂), and that typically additionally comprises water (H₂O), nitrogen (N₂), hydrogen sulfide (H₂S), ammonia (NH₃), oxygen (O₂), volatile organic compounds (VOCs), and/or siloxanes, depending on the biomass from which it is produced. The biogas is upgraded in biogas upgrading 3 to remove the carbon dioxide (CO₂) 45A and the additional components. The low CI biomethane feedstock 10 having a CI that is between 15 gCO₂eq/MJ and −500 gCO₂eq/MJ is sent to the SMR 30 in an oil refinery 20 as described previously with reference to FIG. 1A. In addition, a portion 10A of the low CI biomethane feedstock 10 is recycled to biogas upgrading to fuel the biogas upgrading 3 operation. In another embodiment, the renewable energy source to at least partially power the production process is nuclear, renewable electricity or solar/wind. Using such a renewable energy source to power a production process for producing or upgrading the biogas may reduce the CI of the low CI biomethane feedstock 10.

FIG. 2D shows biomass that is manure 11 from a dairy operation. The manure 11 generates methane 12 that is captured in an anaerobic digestion 1. In many farming operations, methane is not captured. The CI of the biomethane feedstock 10 is reduced by avoiding methane 12 emissions that would otherwise be released into the atmosphere. The gas mixture comprising methane is upgraded in 3 to remove the carbon dioxide (CO₂) 45A and the additional components as described with reference to previous figures. The low CI biomethane feedstock 10 having a CI that is between 15 gCO₂eq/MJ and −500 gCO₂eq/MJ is sent to the SMR 30 in an oil refinery 20 as described.

In order to obtain a desired CI value, one or any combinations of steps (a)-(d) can be used in the practice of embodiments herein. The above embodiments have been provided as examples only. It will be appreciated by those of ordinary skill in the art that various modifications, alternate configurations, and/or equivalents will be employed without departing from the scope of the invention. Accordingly, the scope of the invention is therefore intended to be limited solely by the scope of the appended claims.

1. A method of producing hydrogen that meets a target carbon intensity (CI_{T}) that is 10 gCO₂eq/MJ H₂ (LHV) or lower, the method comprising:
(i) operating a hydrogen production facility that produces hydrogen by reforming gaseous feedstock, the gaseous feedstock comprising non-renewable gaseous feedstock, the reforming generating syngas, the syngas subjected to hydrogen purification, the hydrogen production generating carbon dioxide, at least some of the carbon dioxide captured and provided for sequestration;
(ii) providing biomethane feedstock produced in a biomethane production process that generates carbon dioxide, at least some of the generated carbon dioxide provided for sequestration;
(iii) replacing a fraction of the non-renewable gaseous feedstock used for producing the hydrogen with the biomethane feedstock, thereby producing hydrogen having a carbon intensity reduced relative to hydrogen produced without the replacing,
wherein the non-renewable gaseous feedstock replaced is
(a) feedstock fed to methane reforming,
(b) feedstock used to generate heat for the reforming, or
(c) a combination thereof,
wherein the fraction of the non-renewable gaseous feedstock replaced is less than 50%, and
wherein the fraction is selected to meet the target carbon intensity (CI_{T}); and
(iv) obtaining the hydrogen having the reduced carbon intensity, the reduced carbon intensity being at least as low as the target carbon intensity (CI_{T}) and being dependent, at least in part, on the carbon intensity of the non-renewable gaseous feedstock and the biomethane feedstock.

2. The method according to claim 1, wherein the non-renewable gaseous feedstock replaced comprises the feedstock fed to methane reforming.

3. The method according to claim 1, wherein the reforming comprises steam methane reforming, the steam methane reforming generating the syngas and flue gas.

4. The method according to claim 1, wherein at least some of the captured carbon dioxide from step (i) is captured from off-gas produced from the hydrogen purification, from the syngas, or from hydrogen purification and from the syngas.

5. The method according to claim 3, wherein at least some of the captured carbon dioxide from step (i) is captured from the flue gas.

6. The method according to claim 3, wherein the captured carbon dioxide from step (i) is not captured from the flue gas.

7. The method according to claim 3, wherein no more than 40% of the captured carbon dioxide from step (i) is captured from the flue gas.

8. The method according to claim 3, wherein the replacing in step (iii) comprises replacing at least some of the non-renewable gaseous feedstock fed to steam methane reforming with the biomethane feedstock such that feedstock fed to steam methane reforming has a higher biomethane fraction than feedstock used to generate heat for the reforming.

9. The method according to claim 3, wherein the replacing in step (iii) comprises replacing at least some of the non-renewable gaseous feedstock used to generate heat for the steam methane reforming with the biomethane feedstock such that feedstock fed to steam methane reforming has a lower biomethane fraction than feedstock used to generate heat for the reforming.

10. The method according to claim 1, wherein the hydrogen purification comprises pressure swing adsorption (PSA), and wherein purge gas from the PSA is used to generate heat for the reforming.

11. The method according to claim 1, wherein an amount of non-renewable gaseous feedstock replaced by the biomethane feedstock is less than 30%.

12. The method according to claim 1, wherein the biomethane production process produces digestate, wherein at least part of the digestate is subjected to combustion, gasification, or pyrolysis, thereby generating gas comprising carbon dioxide, and wherein at least a portion of the carbon dioxide from the gas is captured and provided for sequestration.

13. The method according to claim 1, wherein the biomethane production process produces digestate, wherein at least part of the digestate is combusted, thereby generating flue gas comprising carbon dioxide, and wherein at least some of the carbon dioxide from the flue gas is captured and provided for sequestration.

14. The method according to claim 1, wherein the biomethane production process comprises anaerobic digestion or gasification, wherein the biomethane feedstock provided in step (ii) has a carbon intensity value within a range that is between 15 gCO₂eq/MJ and −500 gCO₂eq/MJ, and wherein the carbon intensity value is obtained at least in part by the provision of at least some of the carbon dioxide generated from biomethane production for sequestration in (ii), and by at least one of:
(a′) capturing and sequestering carbon from a residue of the anaerobic digestion or gasification;
(b′) using a renewable energy source to at least partially power the biomethane production process; or
(c′) processing animal waste and avoiding emissions of methane to atmosphere that would otherwise have been released without production and collection of the biomethane feedstock.

15. The method according to claim 1, wherein the fraction of the non-renewable gaseous feedstock replaced with the biomethane feedstock in step (iii), represented by r, is determined by Equation A:
$$r = \frac{( {CI}_{i} - {CI}_{T} - k - {C}_{r} )}{( {CI}_{NRGF} - {CI}_{B} )} \cdot y , \qquad Equation A$$
wherein the CI values CIᵢ, CI_{T}, CI_{NRGF}, and CI_{B} of Equation A are expressed in gCO₂eq/MJ,
CIᵢ=a carbon intensity of the hydrogen when it is assumed that the hydrogen is produced using only non-renewable gaseous feedstock and without accounting for any reductions in CI due to carbon capture and sequestration and without accounting for any reductions in CI due to the use of renewable power,
CI_{T}=the target carbon intensity of the hydrogen to be produced in the hydrogen production facility,
k=net amount of carbon dioxide captured and sequestered per unit of hydrogen produced in gCO₂eq/MJ associated with hydrogen production, and wherein k is zero when no carbon dioxide is captured and sequestered,
Cᵣ=carbon dioxide emissions reduction per unit of hydrogen produced in gCO₂eq/MJ attributable to using renewable power in or associated with hydrogen production,
CI_{NRGF}=the carbon intensity of the non-renewable gaseous feedstock (NRGF) fed to the hydrogen production facility,
CI_{B}=carbon intensity of biomethane feedstock fed to the hydrogen production facility, and
y=a ratio of energy of the hydrogen produced in MJ to the sum of energy of the non-renewable gaseous feedstock in MJ and energy of the biomethane feedstock in MJ.

16. The method according to claim 1, further comprising obtaining one or more credits for the hydrogen that meets the target carbon intensity (CI_{T}), for producing the hydrogen that meets the target carbon intensity (CI_{T}), or a combination thereof.

17. The method according to claim 1, wherein the target carbon intensity (CI_{T}) is 5 gCO₂eq/MJ H₂ (LHV) or lower.

18. The method according to claim 1, wherein the biomethane feedstock provided in step (ii) has a negative carbon intensity value.

19. The method according to claim 1, wherein the hydrogen obtained in step (iv) is used in ammonia production.

20. A method of producing hydrogen that meets a target carbon intensity (CI_{T}) that is 10 gCO₂eq/MJ H₂ (LHV) or lower, the method comprising:
(i) providing biomethane feedstock for hydrogen production, the biomethane feedstock produced in a biomethane production process comprising anaerobic digestion, the anaerobic digestion generating biogas and digestate, the biogas comprising carbon dioxide, at least some of the carbon dioxide from the biogas captured and provided for sequestration, at least a portion of the digestate combusted, combustion of the digestate producing a first flue gas comprising carbon dioxide, at least some of the carbon dioxide from the first flue gas captured and provided for sequestration, the hydrogen production including subjecting gaseous feedstock to steam methane reforming, the gaseous feedstock comprising non-renewable gaseous feedstock, the steam methane reforming generating syngas and a second flue gas, the syngas comprising hydrogen and carbon dioxide, the syngas subjected to hydrogen purification, at least some of the carbon dioxide from the syngas captured and provided for sequestration;
(ii) replacing a fraction of the non-renewable gaseous feedstock used for producing the hydrogen with the biomethane feedstock, thereby producing hydrogen having a carbon intensity reduced relative to hydrogen produced without the replacing,
wherein the non-renewable gaseous feedstock replaced is
(a) feedstock fed to methane reforming,
(b) feedstock used to generate heat for the reforming, or
(c) a combination thereof,
wherein the fraction of the non-renewable gaseous feedstock replaced is less than 50%, and
wherein the fraction is selected to meet the target carbon intensity (CI_{T}); and
(iii) obtaining the hydrogen having the reduced carbon intensity, the carbon intensity being at least as low as the target carbon intensity (CI_{T}) and being dependent, at least in part, on the carbon intensity of the non-renewable gaseous feedstock and the biomethane feedstock.

21. A method of producing ammonia, the method comprising providing the hydrogen that meets the target carbon intensity (CI_{T}) produced according to claim 1 for use in producing the ammonia.

22. A method of producing hydrogen that meets a target carbon intensity (CI_{T}) that is 10 gCO₂eq/MJ H₂ (LHV) or lower, the method comprising:
(i) determining a carbon intensity of hydrogen produced at a hydrogen production facility, the hydrogen production facility configured to produce hydrogen by reforming gaseous feedstock, the reforming generating carbon dioxide, the hydrogen production facility configured to capture at least some of the carbon dioxide, the determined carbon intensity higher than the target carbon intensity (CI_{T}), the determined carbon intensity accounting for the gaseous feedstock comprising non-renewable gaseous feedstock and for the captured carbon dioxide being sequestered;
(ii) determining a fraction of the non-renewable gaseous feedstock to be replaced with biomethane feedstock to produce hydrogen that meets the target carbon intensity (CI_{T}), the biomethane feedstock produced in a biomethane production process that generates carbon dioxide, at least a portion of the carbon dioxide generated provided for sequestration, wherein the non-renewable gaseous feedstock replaced is
(a) feedstock fed to methane reforming,
(b) feedstock used to generate heat for the reforming, or
(c) a combination thereof, and
wherein the fraction of the non-renewable gaseous feedstock replaced is less than 50%; and
(iii) providing the biomethane feedstock for use at the hydrogen production facility, the biomethane feedstock provided used to produce hydrogen in a process comprising:
(a′) providing feedstock comprising the non-renewable gaseous feedstock and the biomethane feedstock for the reforming, thereby generating syngas comprising hydrogen, carbon monoxide, and carbon dioxide, an amount of biomethane feedstock in the feedstock determined in dependence upon the fraction determined in (ii);
(b′) subjecting the syngas to hydrogen purification; and
(c′) capturing at least a portion of the carbon dioxide from the syngas, from off-gas from hydrogen purification, or a combination thereof, and providing the captured carbon dioxide for sequestration,
wherein the hydrogen produced has a carbon intensity that meets the target carbon intensity (CI_{T}) and is dependent, at least in part, on the carbon intensity of the non-renewable gaseous feedstock and the biomethane feedstock.
